(19) United States
(12) Patent Application Publication
(10) Pub. No.: US 2026/0073252 A1
(43) Pub. Date: Mar. 12, 2026

(54) Machine-Learned Model to Determine Acquisition Features Associated with a User

(71) Applicant: Google LLC, Mountain View, CA (US)

(72) Inventors: Tao Chen, Sunnyvale, CA (US); Cheng Li, Mountain View, CA (US); Mingyang Zhang, San Jose, CA (US); Siqi Zuo, Redwood City, CA (US); Qiaozhu Mei, Ann Arbor, MI (US); Michael Bendersky, Cupertino, CA (US)

(21) Appl. No.: 18/883,347

(22) Filed: Sep. 12, 2024

(51) Int. Cl. G06N 5/04

(52) U.S. Cl. CPC G06N 5/04

(57) ABSTRACT

A computing device for generating a dataset includes one or more memories to store instructions and one or more processors to execute the instructions to perform operations, the operations including: implementing one or more machine-learned models to determine one or more acquisition features associated with a user relating to a first item prior to the user interacting with the first item; implementing the one or more machine-learned models to determine one or more experiential features relating to interactions with the first item or one or more other items; and generating a dataset based on the one or more acquisition features and the one or more experiential features.

### FIELD

This disclosure relates generally to machine learning processes and machine-learned devices and systems. More particularly, the disclosure relates to implementing one or more machine-learned models to improve recommendation systems by determining both acquisition features and experiential features relating to an item.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Various methods exist for generating explanations in the context of explainable recommender systems. Some methods use a product description as a ground truth explanation, however such methods are not personalized. Some methods extract various information from user reviews which capture user satisfaction, but do not capture motives for obtaining an item.

Existing approaches for explanation generation, such as ranking-based and template-based methods, tend to produce generic explanations with limited language flexibility and personalization. Natural language generation (NLG) methods can be used to generate free-text explanations. Large language models (LLMs) can also be used for text generation and to evaluate the quality of generated text across various domains.

Existing methods can generate an explanation based on a review of an item by utilizing user reviews to mine the explanations. One method extracts the most commonly occurred near-duplicate sentences across reviews, resulting in short and generic comments about the items. For instance, “Excellent movie” is the top extracted explanation in an entertainment review dataset. Other methods extract review sentences or segments that mention one or more pre-selected item features/aspects. An example explanation is “The quality of the material is great” where “quality” and “material” are two features of the item.

Previous methods for implementing recommendation systems focus on extracting users'post-acquisition sentiment in reviews, however these methods ignore the reasons behind the decision to acquire items.

### SUMMARY

Aspects and advantages of embodiments of the disclosure will be set forth in part in the following description, or can be learned from the description, or can be learned through practice of the embodiments.

Example aspects of the disclosure provide an example computing device that includes one or more processors and one or more example non-transitory computer-readable media storing instructions that are executable by the one or more processors to cause the computing device to perform example operations. In some implementations, the example operations can include implementing one or more machine-learned models configured to: determine one or more acquisition features associated with a user relating to a first item prior to the user interacting with the first item, and determine one or more experiential features relating to interactions with the first item or one or more other items; and generating a dataset based on the one or more acquisition features and the one or more experiential features.

In some implementations, the operations further comprise obtaining information from one or more reviews associated with the first item and/or at least one other item, and the one or more machine-learned models are configured to determine the one or more acquisition features associated with the user based on the information from the one or more reviews associated with the first item and/or the at least one other item.

In some implementations, the operations further comprise generating a rationale for determining the one or more acquisition features.

In some implementations, the one or more acquisition features include a first acquisition feature which is determined based on information associated with the user which explicitly indicates one or more reasons for the user acquiring the first item prior to interacting with the first item.

In some implementations, the one or more acquisition features include a second acquisition feature which is determined based on information associated with the user which implicitly indicates one or more reasons for the user acquiring the first item prior to interacting with the first item.

In some implementations, the one or more experiential features include a first experiential feature which is determined based on information associated with the user or one or more other users which indicates whether the first item satisfied expectations of the user or the one or more other users after interacting with the first item.

In some implementations, the operations further comprise: determining, based on the one or more acquisition features associated with the user included in the dataset, information indicating one or more reasons for the user desiring to obtain the first item; and providing, for presentation to the user, a recommendation related to a second item, based on the information indicating the one or more reasons for the user desiring to obtain the first item and one or more experiential features included in the dataset relating to the second item.

In some implementations, the operations further comprise: receiving a query related to a second item from the user; in response to receiving the query, determining, based on the one or more acquisition features associated with the user included in the dataset, information indicating one or more reasons for the user desiring to obtain the first item; and providing, for presentation to the user, a recommendation related to the second item, based on the information indicating the one or more reasons for the user desiring to obtain the first item and one or more experiential features included in the dataset relating to the second item.

In some implementations, the one or more acquisition features are specified separately from the one or more experiential features in the dataset.

In some implementations, the operations further comprise obtaining information from a plurality of reviews associated with the user relating to a plurality of items other than the first item, and the one or more machine-learned models are configured to determine the one or more acquisition features associated with the user based on the information from the plurality of reviews associated with the user relating to the plurality of items other than the first item.

In some implementations, wherein the one or more machine-learned models are configured to limit a number of reviews associated with the user for determining the one or more acquisition features to a predetermined number of reviews most recently provided by the user.

Example aspects of the disclosure provide an example computing device that includes one or more processors and one or more example non-transitory computer-readable media storing instructions that are executable by the one or more processors to cause the computing device to perform example operations. In some implementations, the example operations can include receiving a query from a user relating to a first item; and in response to receiving the query, implementing one or more machine-learned models configured to: determine one or more acquisition features associated with the user relating to the first item prior to the user interacting with the first item, determine one or more experiential features relating to interactions with the first item or one or more other items, and provide, as an output, a recommendation of the first item based on the one or more acquisition features and the one or more experiential features.

In some implementations, the one or more acquisition features associated with the user relating to the first item prior to the user interacting with the first item are retrieved by the one or more machine-learned models from a dataset which stores the one or more acquisition features associated with the user.

In some implementations, the one or more machine-learned models are implemented in real-time.

Example aspects of the disclosure provide an example computing device that includes one or more processors and one or more example non-transitory computer-readable media storing instructions that are executable by the one or more processors to cause the computing device to perform example operations. In some implementations, the example operations can include determining an occurrence of a predetermined condition with respect to a user; and in response to determining the occurrence of the predetermined condition, implementing one or more machine-learned models configured to: determine one or more acquisition features associated with the user relating to a first item prior to the user interacting with the first item, determine one or more experiential features relating to interactions with the first item or one or more other items, and provide, as an output, a recommendation of the first item based on the one or more acquisition features and the one or more experiential features.

In some implementations, the one or more acquisition features associated with the user relating to the first item prior to the user interacting with the first item are retrieved by the one or more machine-learned models from a dataset which stores the one or more acquisition features associated with the user.

In some implementations, the one or more machine-learned models are implemented in real-time.

In some implementations, the predetermined condition includes at least one of the user requesting to access content via a particular website, receiving an instruction provide a notification to the user, or determining a user has entered a particular geographic location.

Example aspects of the disclosure provide an example computer-implemented method. In some implementations, the example computer-implemented method can include: implementing, by a computing system comprising one or more processors, one or more machine-learned models to determine one or more acquisition features associated with a user relating to a first item prior to the user interacting with the first item; implementing, by the computing system, the one or more machine-learned models to determine one or more experiential features relating to interactions with the first item or one or more other items; and generating a dataset based on the one or more acquisition features and the one or more experiential features.

In some implementations, the computer-implemented method includes obtaining information from one or more reviews associated with the first item and/or at least one other item, and the one or more machine-learned models determine the one or more acquisition features associated with the user based on the information from the one or more reviews associated with the first item and/or the at least one other item.

In some implementations, the computer-implemented method includes generating a rationale for determining the one or more acquisition features.

In some implementations, the one or more acquisition features include a first acquisition feature which is determined based on information associated with the user which explicitly indicates one or more reasons for the user acquiring the first item prior to interacting with the first item.

In some implementations, the one or more acquisition features include a second acquisition feature which is determined based on information associated with the user which implicitly indicates one or more reasons for the user acquiring the first item prior to interacting with the first item.

In some implementations, the one or more experiential features include a first experiential feature which is determined based on information associated with the user or one or more other users which indicates whether the first item satisfied expectations of the user or the one or more other users after interacting with the first item.

In some implementations, the computer-implemented method includes determining, based on the one or more acquisition features associated with the user included in the dataset, information indicating one or more reasons for the user desiring to obtain the first item; and providing, for presentation to the user, a recommendation related to a second item, based on the information indicating the one or more reasons for the user desiring to obtain the first item and one or more experiential features included in the dataset relating to the second item.

In some implementations, the computer-implemented method includes receiving a query related to a second item from the user; in response to receiving the query, determining, based on the one or more acquisition features associated with the user included in the dataset, information indicating one or more reasons for the user desiring to obtain the first item; and providing, for presentation to the user, a recommendation related to the second item, based on the information indicating the one or more reasons for the user desiring to obtain the first item and one or more experiential features included in the dataset relating to the second item.

The computer-implemented method may execute any of the operations of the computing device as described herein.

Example aspects of the disclosure provide one or more example non-transitory computer-readable media storing instructions that are executable by one or more processors to cause a computing system to perform example operations. In some implementations, the example operations can include implementing one or more machine-learned models to determine one or more acquisition features associated with a user relating to a first item prior to the user interacting with the first item; implementing the one or more machine-learned models to determine one or more experiential features relating to interactions with the first item or one or more other items; and generating a dataset based on the one or more acquisition features and the one or more experiential features.

The non-transitory computer-readable medium may store additional instructions to execute other aspects and operations of the computing device and computer-implemented method as described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

FIG. 1A is an example system, according to one or more example embodiments of the disclosure;

FIG. 1B is an example block diagram of a computing system, according to one or more example embodiments of the disclosure;

FIGS. 2A-2C each illustrate a flow diagram of an example, non-limiting computer-implemented method, according to one or more example embodiments of the disclosure;

FIG. 3 illustrates an example block diagram of a system including an item recommendation application, according to one or more example embodiments of the disclosure;

FIG. 4 illustrates an example block diagram of a system including an item recommendation application, according to one or more example embodiments of the disclosure;

FIGS. 5A-5D are example dataset results obtained by implementing one or more machine-learned models, according to one or more example embodiments of the disclosure;

FIGS. 6A-6B illustrate example dataset results obtained by implementing one or more machine-learned models compared to other dataset results obtained from other methods, according to one or more example embodiments of the disclosure;

FIGS. 7A-7B illustrate example dataset results obtained by implementing one or more machine-learned models compared to other dataset results obtained from other methods, according to one or more example embodiments of the disclosure;

FIGS. 8A-8E illustrate example prompts for recommendation system tasks, according to one or more example embodiments of the disclosure;

FIGS. 9A-9F illustrate example experimental results, according to one or more example embodiments of the disclosure;

FIG. 10 is a flow chart diagram illustrating an example method for training a machine-learned model according to example implementations of aspects of the disclosure;

FIG. 11 is a block diagram of an example processing flow for using machine-learned model(s) to process input(s) to generate output(s) according to example implementations of aspects of the disclosure;

FIG. 12 is a block diagram of an example sequence processing model according to example implementations of aspects of the disclosure;

FIG. 13 is a block diagram of an example technique for populating an example input sequence for processing by a sequence processing model according to example implementations of aspects of the disclosure;

FIG. 14 is a block diagram of an example model development platform according to example implementations of aspects of the disclosure;

FIG. 15 is a block diagram of an example training workflow for training a machine-learned model according to example implementations of aspects of the disclosure;

FIG. 16 is a block diagram of an inference system for operating one or more machine-learned model(s) to perform inference according to example implementations of aspects of the disclosure;

FIG. 17 is a block diagram of an example networked computing system according to example implementations of aspects of the disclosure;

FIG. 18 is a block diagram of an example computing device according to example implementations of aspects of the disclosure; and

FIG. 19 is a block diagram of an example computing device according to example implementations of aspects of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Explanations are useful for enhancing user trust and understanding within modern recommendation systems. Previous methods for implementing recommendation systems focus on extracting users'post-acquisition sentiment in reviews, however these methods ignore the reasons behind the decision of a user to obtain an item. Further, previous methods often produce generic explanations, use frequently occurring phrases, and discard or overlook information that pertains to a user's personal motivations for obtaining an item.

According to example computing systems and methods of the disclosure, one or more machine-learned models are implemented to generate a high-quality dataset which includes information relating to the reasons or factors which motivate a user to obtain an item (e.g., information relating to reasons for why a user makes a particular decision for obtaining an item). In some implementations, the one or more machine-learned models are trained to distinguish between information indicating the reasons a user obtains an item (e.g., prior to obtaining the item) and information indicating the satisfaction or dissatisfaction the user has with the item after experience of using the item (e.g., based on user reviews of the item after the user has obtained and experienced the item).

Providing user-understandable explanations to justify recommendations can enhance the effectiveness, persuasiveness, and user satisfaction of a recommendation. For example, explanations can be presented in various styles, such as text (e.g., one or more sentences, a paragraph, etc.), a relevant user or item, a chart, an image, or a set of reasoning rules. For example, natural language generation techniques can be used to generate a short narrative (e.g., a sentence, a paragraph, etc.) to provide the explanation.

Since reviews are written after a user has obtained an item, a user's sentiments towards the item may primarily be based on a post-acquisition user experience. Existing explanation datasets, therefore, focus on how the item was commented on, rather than the reasons behind the initial decision to obtain the item. In other words, these explanations are good for understanding whether a user is satisfied (or dissatisfied) by an item after obtaining the item, rather than why the user desired to obtain the item prior to interacting with the item. Understanding the reasons or motivation for obtaining an item can improve personalized recommendation systems, especially because recommendations are often made before the user actually obtains an item or has interacted with the item. This information can indicate motivations and needs associated with a user (e.g., which may be associated with a particular item or a plurality of items). The information can further be used to generate an enhanced and enriched dataset associated with the personalized recommendation system, with more comprehensive and persuasive explanations for recommending a particular item and/or with more comprehensive and persuasive explanations associated with reasons for why a user makes a decision to obtain an item along with reasons for why a user is satisfied or not satisfied with a particular item. Further, such information can be associated with a user profile for future recommendations regarding other items.

According to example computing systems and methods of the disclosure, one or more machine-learned models are implemented to perform an acquisition reason task that leverages one or more machine-learned models (e.g., one or more large-language models) to generate a dataset from user reviews, capturing reasons for obtaining an item, and capturing information relating to interactions with the item after the user has obtained the item. The resulting dataset is a high-quality, personalized set of explanations.

According to example computing systems and methods of the disclosure, one or more machine-learned models are implemented to generate explanations based on the content of the dataset. For example, the explanations can be associated with the relevance of an item to the needs of the user (e.g., a reason for obtaining the item) and preference information relating to the item (e.g., experience information relating to the item after the user has interacted with the item).

One or more technical benefits of the disclosure include the implementation of one or more machine-learned models which identify or generate explanations (summaries) which include acquisition features indicating reasons a user desired to obtain an item before interacting with the item and experiential features indicating whether a user was satisfied with the item after interacting with the item. The computing systems and methods described herein improve the quality and diversity of a resulting dataset which is generated based on the generated explanations which can be associated with a particular user, item, category or genre of item etc., reducing or eliminating the need for manual annotation. For example, the computing systems and methods described herein can improve and be implemented in a recommendation system that is configured to generate recommendations for an item based on the information provided in the dataset. The machine-learned models described herein can conserve computing resources including processing power, memory, network resources (e.g., bandwidth), etc., by providing more relevant search (recommendation) results, reducing the need for additional searching by the user, and saving time and computing resources by not requiring the user to input or edit search parameters for finding items relevant to a query of the user. Further, recommendations can be provided to the user independently of a user query which are more relevant to the user, based on the improved dataset generated according to the computing systems and methods described herein. Further, in some implementations the machine-learned models described herein can be embodied by pre-existing machine-learned models that are capable of processing prompts as described herein to identify or generate explanations which include acquisition features indicating reasons a user desired to obtain an item before interacting with the item and experiential features indicating whether a user was satisfied with the item after interacting with the item, thereby improving the performance of a recommendation system. For example, enabling the reuse of a pre-existing machine-learned model with the new techniques described herein, can save or conserve storage on a computing device and/or time for training because it is not necessary to train and store a new model.

Therefore, aspects of the disclosure provide technical effects, benefits, and/or improvements in computing technology and the technology of recommendation systems and datasets, via one or more computing devices (e.g., a user computing device, a server computing system, and combinations thereof) which implement one or more machine-learned models, as described herein.

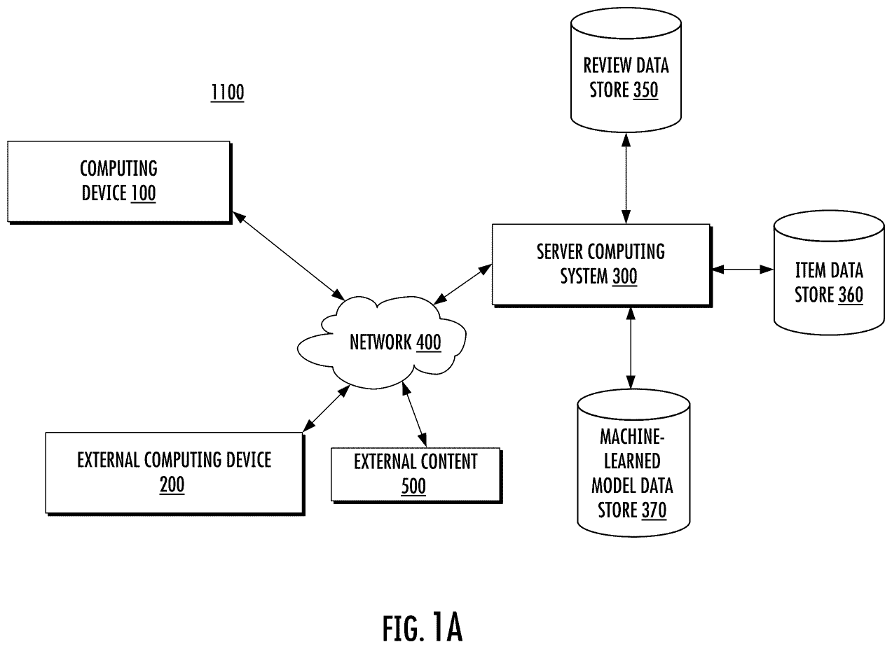

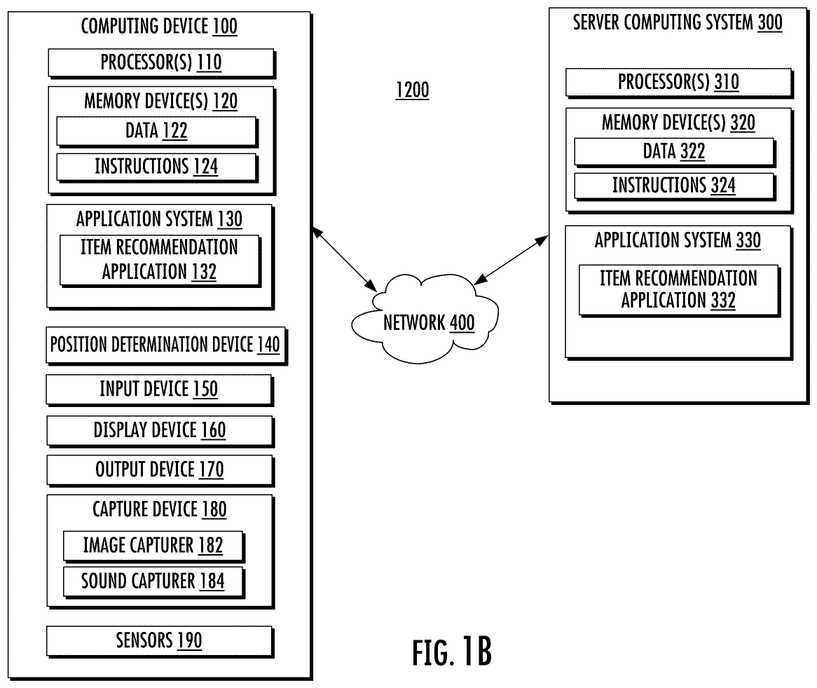

Referring now to the drawings, FIG. 1A is an example system according to one or more example embodiments of the disclosure. FIG. 1A illustrates an example of a system 1100 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a laptop, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can provide a tool for a recommendation system by which, via one or more machine-learned models, acquisition features and experiential features relating to an item can be determined, a dataset including the acquisition features and experiential features can be generated, and recommendations pertaining to an item can be provided based on the acquisition features and experiential features.

In some example embodiments, the server computing system 300 may obtain data from one or more of a review data store 350, an item data store 360, and a machine-learned model data store 370, to implement various operations and aspects of the application system as disclosed herein. The review data store 350, item data store 360, and machine-learned model data store 370 may be integrally provided with the server computing system 300 (e.g., as part of the one or more memory devices 320 of the server computing system 300) or may be separately (e.g., remotely) provided. Further, review data store 350, item data store 360, and machine-learned model data store 370 can be combined as a single data store (database) or may include a plurality of respective data stores. Data stored in one data store (e.g., the review data store 350) may overlap with some data stored in another data store (e.g., item data store 360). In some implementations, one data store (e.g., the machine-learned model data store 370) may reference data that is stored in another data store (e.g., the review data store 350 and/or the item data store 360).

In some implementations, the review data store 350 can store information relating to reviews of an item. For example, the item can include a product (good) or can include a service. The review may include information relating to a user's experience with the item (experiential information) after the user has interacted with the item. In some implementations, the review may include information relating to reasons why a user decided to obtain the item (e.g., for reasons personal to the user, for reasons relating to characteristics of the item that met certain specifications of the user, etc.). In some implementations, the review may include information about the item itself. In some implementations, the information stored in the review data store 350 can be associated with and/or stored according to a particular user or a plurality of users, according to a particular category, genre, context, time, location, item type, etc. In some implementations, the information stored in the review data store 350 can be associated with and/or stored according to a particular environment (e.g., outdoor, indoor, etc.). In some implementations, the information stored in the review data store 350 can be associated with and/or stored according to a particular entity that is associated with the item (e.g., an entity that provides the item, that makes the item, etc.).

In some implementations, the item data store 360 can store data associated with items. For example, the item can include a product (good) or can include a service. The item data store 360 can include information which is descriptive of the item (e.g., technical specifications regarding the item, brand information, cost information, availability information, identification information, compliance or legal information, durability information, appearance or aesthetic information, rating information, etc.).

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of applications, types of items, etc., that may be implemented across a variety of domains (e.g., healthcare, gaming, engineering/science, entertainment, travel, retail, etc.). The machine-learned models may include large language models and general, multimodal models (e.g., Gemini). The machine-learned models may include generative artificial intelligence (AI) models which may implement generative adversarial networks (GANs), transformers, variational autoencoders (VAEs), neural radiance fields (NeRFs), and the like.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

FIG. 1B is an example block diagram of a computing system, according to one or more example embodiments of the disclosure. Referring now to FIG. 1B, example block diagrams of a system 1200 including a computing device 100 and server computing system 300 according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, an application system 130, a position determination device 140, an input device 150, a display device 160, an output device 170, and a capture device 180. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement item recommendation application 132, and to execute the instructions to perform operations including implementing one or more machine-learned models to determine acquisition features and experiential features relating to an item, generate a dataset including the acquisition features and experiential features, and provide recommendations pertaining to an item based on the acquisition features and experiential features, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement item recommendation application 332, and to execute the instructions to perform operations including implementing one or more machine-learned models to determine acquisition features and experiential features relating to an item, generate a dataset including the acquisition features and experiential features, and provide recommendations pertaining to an item based on the acquisition features and experiential features, as described according to examples of the disclosure.

In some example embodiments, the computing device 100 includes an application system 130. For example, the application system 130 may include the item recommendation application 132. The application system 130 can include various other applications including search applications, gaming applications, document applications, text messaging applications, email applications, dictation applications, virtual keyboard applications, browser applications, map applications, social media applications, navigation applications, etc.

According to examples of the disclosure, the item recommendation application 132 may be executed by the computing device 100 to determine acquisition features and experiential features relating to an item, generate a dataset including the acquisition features and experiential features, and/or provide recommendations pertaining to an item based on the acquisition features and experiential features, via one or more machine-learned models. In some implementations, the item recommendation application 132 may be part of another application (e.g., a search application, health application, gaming application, etc.) or may be a standalone application. The item recommendation application 132 may be configured to be dynamically interactive according to various user inputs. Example implementations of the item recommendation application 132 are described herein, however the disclosure is not limited to these examples as various modifications may be made to the embodiments described herein.

In some examples, one or more aspects of the item recommendation application 132 may be implemented by the item recommendation application 332 of the server computing system 300 which may be remotely located, to provide a user of the computing device 100 a way to determine acquisition features and experiential features relating to an item, generate a dataset including the acquisition features and experiential features, and/or provide recommendations pertaining to an item based on the acquisition features and experiential features, via one or more machine-learned models. In some examples, one or more aspects of the item recommendation application 332 may be implemented by the item recommendation application 132 of the computing device 100, to determine acquisition features and experiential features relating to an item, generate a dataset including the acquisition features and experiential features, and/or provide recommendations pertaining to an item based on the acquisition features and experiential features, via one or more machine-learned models.

In some example embodiments, the computing device 100 includes a position determination device 140. Position determination device 140 can determine a current geographic location of the computing device 100 and communicate the geographic location to the server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the computing device 100. For example, in some implementations the item recommendation application 132 may be configured to utilize position information determined by the position determination device 140 in connection with providing recommendations pertaining to an item.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the item recommendation application 132, for providing feedback to the item recommendation application 132, for communicating with other users, for accepting or declining suggestions or recommendations provided by the computing device 100 with respect to an item, for providing or editing a review of an item, for providing a query (e.g., a search query), etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to the recommendation of an item, relating to a review of an item, relating to the output of the determined acquisition features and experiential features, relating to information about an item, relating to a rationale for the recommendation of an item and/or the identification of determined acquisition features and experiential features, etc. The display device 160 can be configured to provide, for presentation to a user, one or more user interface screens having user interface elements which are selectable by the user for obtaining a recommendation of an item, for providing a review of an item, for obtaining acquisition features and experiential features relating to an item, for obtaining information relating to an item, for providing feedback or instructions (guidance) to a user regarding an item, etc.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to a recommendation of an item, relating to a review of an item, relating to determined acquisition features and experiential features associated with an item, relating to information descriptive of an item, for providing feedback or instructions (guidance) to a user regarding an item, etc.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the image capturer 182 can include one or more cameras having an imaging sensor (e.g., a complementary metal-oxide-semiconductor (CMOS) or charge-coupled device (CCD)). For example, the capture device 180 can include a sound capturer 184 (e.g., a microphone) which is configured to capture sound or audio (e.g., an audio recording). The media content captured by the capture device 180 may be transmitted to one or more of the server computing system 300, review data store 350, item data store 360, and machine-learned model data store 370, for example, via network 400. For example, in some implementations, content which is captured by the capture device 180 may be provided as an input to one or more machine-learned models for various tasks associated with the recommendation system and item recommendation application 132, described herein.

The computing device 100 may include one or more sensors 190. For example, the one or more sensors 190 may include an inertial measurement unit which includes one or more accelerometers and/or one or more gyroscopes. The one or more accelerometers and one or more gyroscopes may be used to capture motion information with respect to the computing device 100. The motion information obtained via the inertial measurement unit may be associated with the user when the computing device 100 is worn or carried by the user. For example, the one or more sensors 190 may include one or more optical sensors (e.g., one or more photoplethysmography (PPG) sensors, one or more electrocardiogram sensors, etc.). The one or more sensors 190 may also include other sensors such as a magnetometer, proximity sensor, Hall effect sensor, and the like. For example, in some implementations, content which is captured by the one or more sensors 190 may be provided as an input to one or more machine-learned models for various tasks associated with the recommendation system and item recommendation application 132, described herein.

In accordance with example embodiments of the disclosure, the server computing system 300 can include one or more processors 310 and one or more memory devices 320 as described herein. The server computing system 300 may also include an application system 330 which is similar to the application system 130 described herein.

For example, the application system 330 may include the item recommendation application 332 which performs functions similar to those described herein with respect to item recommendation application 132. In some implementations, one or more machine-learned models (e.g., generative machine-learned models, large language models, etc.) associated with the item recommendation application 332 may be configured to determine acquisition features and experiential features relating to an item, generate a dataset including the acquisition features and experiential features, and provide recommendations pertaining to an item based on the acquisition features and experiential features, as described according to examples of the disclosure. In some implementations, the item recommendation application 332 may be part of another application (e.g., a search application, health application, gaming application, etc.) or may be a standalone application.

For example, one or more machine-learned models (e.g., generative machine-learned models, large language models, etc.) associated with the application system 330 may be configured to perform a first action (e.g., implementing one or more machine-learned models to determine one or more acquisition features associated with a user relating to a first item prior to the user interacting with the first item, and determine one or more experiential features relating to interactions with the first item or one or more other items), while the computing device 100 may be configured to perform a second action (e.g., generating a dataset based on the one or more acquisition features and the one or more experiential features). For example, one or more machine-learned models (e.g., generative machine-learned models, large language models, etc.) associated with the application system 130 may be configured to perform a first action (e.g., implementing one or more machine-learned models to determine one or more acquisition features associated with a user relating to a first item prior to the user interacting with the first item, and determine one or more experiential features relating to interactions with the first item or one or more other items), while the server computing system 300 may be configured to perform a second action (e.g., generating a dataset based on the one or more acquisition features and the one or more experiential features).

Examples of the disclosure are directed to computer implemented methods for recommendation systems including implementing one or more machine-learned models to determine acquisition features and experiential features relating to an item, generate a dataset including the acquisition features and experiential features, and provide recommendations pertaining to an item based on the acquisition features and experiential features.

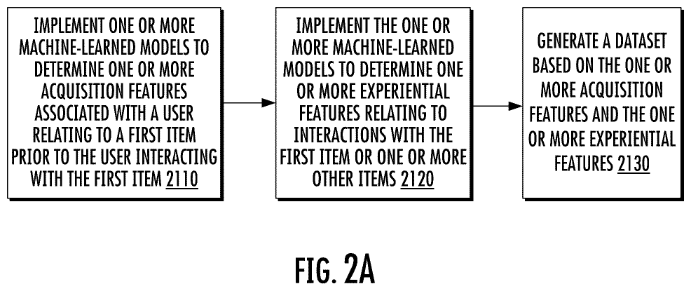

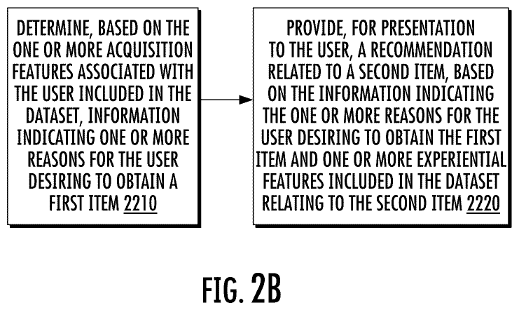

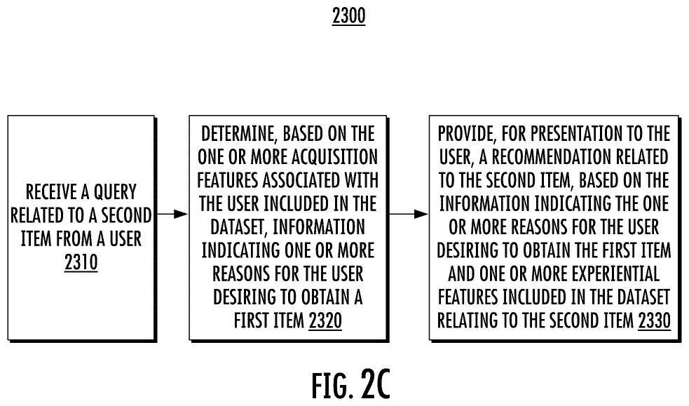

The flow diagram of FIG. 2A illustrates a method 2100 for generating a dataset based on one or more acquisition features and one or more experiential features related to an item, by implementing one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The flow diagram of FIG. 2B illustrates a method 2200 for providing a recommendation related to a second item based on information indicating one or more reasons for a user desiring to obtain a first item and one or more experiential features included in the dataset relating to the second item, by implementing the one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The flow diagram of FIG. 2C illustrates a method 2300 for, in response to receiving a query related to a second item from a user, providing a recommendation related to the second item based on information indicating one or more reasons for a user desiring to obtain a first item and one or more experiential features included in the dataset relating to the second item, by implementing the one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

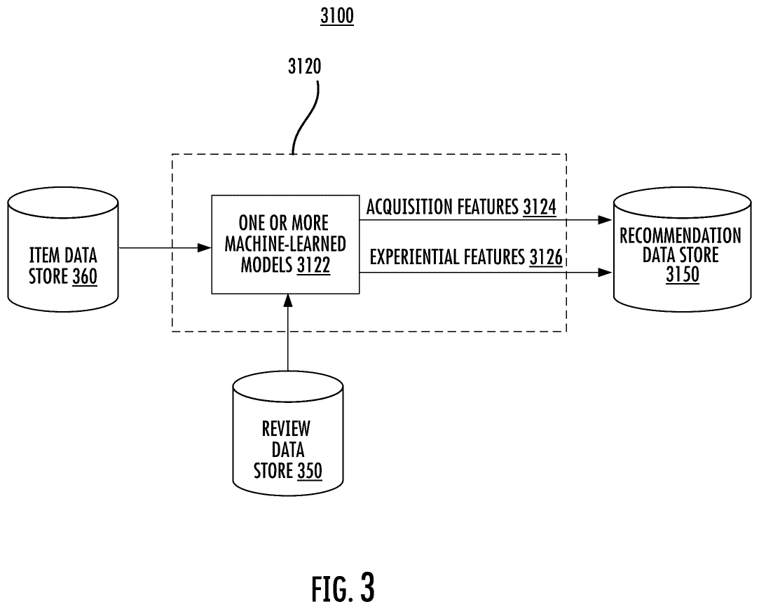

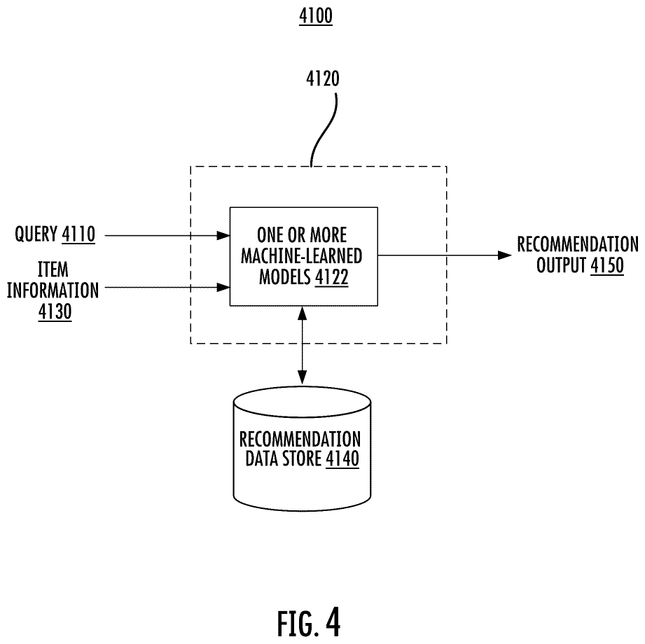

The operations of FIGS. 2A-2C will be explained with reference to FIGS. 3-4. FIGS. 3-4 illustrate example block diagrams of systems including an item recommendation application, according to one or more example embodiments of the disclosure.

Referring to FIG. 2A, at operation 2110 the method 2100 includes a computing device implementing one or more machine-learned models to determine one or more acquisition features associated with a user relating to a first item prior to the user interacting with the first item. As described herein, the computing device may be embodied as computing device 100, server computing system 300, or combinations thereof.

For example, in the computing system 3100 of FIG. 3, the item recommendation application 3120 may be configured to implement the one or more machine-learned models 3122 to determine one or more acquisition features 3124 associated with a user relating to a first item prior to the user interacting with the first item. Information about the first item may be input to (or retrieved or obtained by) the one or more machine-learned models 3122 from the item data store 360 for purposes of the one or more machine-learned models 3122 determining the one or more acquisition features 3124. In addition, in some implementations information from one or more item reviews may be input to (or retrieved or obtained by) the one or more machine-learned models 3122 from the review data store 350 for purposes of the one or more machine-learned models 3122 determining the one or more acquisition features 3124. For example, the one or more machine-learned models 3122 may be configured to determine the one or more acquisition features 3124 associated with the user based on the information from the one or more reviews associated with the first item and/or at least one other item. In some implementations, the one or more machine-learned models 3122 may be configured to limit the number of reviews associated with the user and/or with other users for determining the one or more acquisition features 3124. For example, the number of reviews may be limited to a predetermined number of reviews (e.g., five reviews, ten reviews, etc.). For example, the number of reviews may be limited to a predetermined number of most-recent reviews (e.g., the five most recent reviews, the ten most recent reviews, etc.). In some implementations, the length of the reviews may also be limited (e.g., to a maximum predetermined number of tokens, such as 8,000 tokens, 10,000 tokens, etc.). Limiting the number of reviews and/or tokens can conserve computing resources including processing power, storage, bandwidth, etc.

In some implementations, an item can include a product (good) or a service. In some implementations, the one or more machine-learned models 3122 can be stored at or retrieved from machine-learned model data store 370 (e.g., according to an item type or category). For example, the one or more machine-learned models 3122 can include one or more large-language models, generative models, etc.

For example, the one or more acquisition features 3124 include information which reflects, or is representative of, a user's reason or desire to obtain an item, which can be reasons that are personal or unique to the user (e.g., to celebrate a child's birthday, a job promotion, etc.). The one or more acquisition features 3124 can include information which indicates the user's motivation or need for obtaining the item. The one or more acquisition features 3124 can also include information which indicates features which a user values with respect to the item or another item that incorporates the item, or features that should satisfy certain criteria personal to the user or their situation (e.g., technical specifications regarding the item, brand information, cost information, availability information, compliance or legal information, durability information, appearance or aesthetic information, rating information, etc.). In some implementations, the one or more acquisition features 3124 can be derived from reviews by the user pertaining to the item and/or can be derived from reviews by the user pertaining to other items. As described herein, the one or more acquisition features 3124 relate to information which indicates the user's motivation or need for obtaining the item, before the user has actually obtained the item or interacted with the item. For example, the one or more acquisition features 3124 relate to information which indicates the reasons or factors that led (or might lead) the user to obtain an item. In some implementations, the one or more machine-learned models 3122 may be configured to determine (e.g., infer) the one or more acquisition features 3124 from information obtained via the item data store 360 (e.g., item information or item metadata), in response to determining that reviews by the user pertaining to the item and/or reviews by the user pertaining to other items (e.g., which may belong to the same category, genre, etc.) are not available or do not exist.

In some implementations, the one or more machine-learned models 3122 may be configured to classify or categorize the one or more acquisition features 3124 as explicit acquisition features or implicit acquisition features. For example, the one or more acquisition features 3124 can include a first acquisition feature which is determined based on information associated with the user which explicitly indicates one or more reasons for the user acquiring the first item prior to interacting with the first item, and a second acquisition feature which is determined based on information associated with the user which implicitly indicates one or more reasons for the user acquiring the first item prior to interacting with the first item.

For example, the one or more machine-learned models 3122 may be configured to classify or categorize the one or more acquisition features 3124 as explicit acquisition features when the information indicating the user's motivation or need for obtaining the item (before the user has actually obtained the item or interacted with the item) is directly stated in a review. For example, the one or more machine-learned models 3122 may be configured to classify or categorize the one or more acquisition features 3124 as implicit acquisition features when the information indicating the user's motivation or need for obtaining the item (before the user has actually obtained the item or interacted with the item) is not directly stated in the review. For example, the implicit acquisition features can be inferred from the content of the review of the item or can be inferred from the content of a review from another item (e.g., according to information about the item or other item in the review data store 350), or can be inferred from a description of the item (e.g., according to information including metadata about the item in the item data store 360). For example, separating or distinguishing the acquisition features 3124 as explicit acquisition features or implicit acquisition features can reduce hallucinations by the one or more machine-learned models 3122 (e.g., information that is irrelevant or not described or implied in the item description information or the user review). For example, the one or more machine-learned models 3122 may be configured to accord greater weight to explicit acquisition features compared to implicit acquisition features (e.g., when the one or more machine-learned models 3122 assess or evaluate the quality of an explanation relating to the item that is generated based on the one or more acquisition features 3124, when the one or more machine-learned models 3122 recommend an item to a user based on the explanation relating to the item, etc.).

At operation 2120 the method 2100 includes implementing the one or more machine-learned models to determine one or more experiential features relating to interactions with the first item or one or more other items. For example, in FIG. 3, the one or more machine-learned models 3122 may be configured to determine one or more experiential features 3126 relating to a first item or other items after the first item or other items have been experienced (interacted with), for example, based on the content of user reviews concerning the first item or other items. Information about the first item or other items may be input to (or retrieved by) the one or more machine-learned models 3122 from the item data store 360 for purposes of the one or more machine-learned models 3122 determining the one or more experiential features 3126. For example, the one or more experiential features 3126 include information which reflects, or is representative of, a user's satisfaction or dissatisfaction with respect to an item, after the user has experienced or interacted with the item. The one or more experiential features 3126 can include information which rates the item (e.g., on a particular scale or rating system).

In addition, information from one or more item reviews may be input to (or retrieved by) the one or more machine-learned models 3122 from the review data store 350 for purposes of the one or more machine-learned models 3122 determining the one or more experiential features 3126. In some implementations, the item can include a product (good) or a service. In some implementations, the one or more machine-learned models 3122 can be stored at or retrieved from machine-learned model data store 370 (e.g., according to an item type or category). For example, the one or more machine-learned models 3122 can include one or more large-language models, generative models, etc.

For example, the one or more experiential features 3126 can include a first experiential feature which is determined based on information provided by the user or one or more other users which indicates whether the first item satisfied expectations of the user or the one or more other users, after interacting with the first item. The one or more experiential features 3126 can include information which indicates features that a user is satisfied with or dissatisfied with after using the item or having an experience with the item. For example, the one or more experiential features 3126 can be determined from a user review which indicates whether certain features associated with the item satisfied certain performance criteria which may be personal to the user or their situation (e.g., whether certain technical specifications were met, whether the reputation or brand of the item was satisfied, whether the cost of the item met expectations, whether the item was obtained in a timely manner, whether the item was available or in stock, whether the item satisfied certain compliance or legal criteria, whether the item met durability expectations, whether the item's appearance or aesthetic qualities satisfied expectations, etc.). In some implementations, the one or more experiential features 3126 can be derived from reviews by the user pertaining to the item and/or can be derived from reviews from other users. As described herein, the one or more experiential features 3126 relate to information which can indicate the user's satisfaction with the item and/or other users'satisfaction with the item.

In some implementations, operations 2110 and 2120 (e.g., generation tasks which output the one or more acquisition features 3124 and the one or more experiential features 3126) can be performed by the one or more machine-learned models 3122 based on a single prompt which distinguishes between first information (acquisition features) indicating the reasons for desiring to obtain an item and second information (experiential features) indicating the user's satisfaction or dissatisfaction with the item after the user has obtained and experienced (interacted with) the item.

At operation 2130 the method 2100 includes the computing device generating a dataset based on the one or more acquisition features and the one or more experiential features. For example, the one or more machine-learned models 3122 may be configured to output the determined one or more acquisition features 3124 and the one or more experiential features 3126 to the recommendation data store 3150 as indicated in FIG. 3. The recommendation data store 3150 can be included the computing system 1100 or computing system 1200, for example. For example, the one or more acquisition features 3124 can be specified separately from the one or more experiential features 3126 in the dataset (e.g., the recommendation data store 3150). For example, data associated with the one or more acquisition features 3124 can be stored in a particular table or specified partitions while data associated with the one or more experiential features 3126 can be stored in another particular table or other specified partitions.

Referring to FIG. 2B, at operation 2210 the method 2200 includes a computing device determining, based on the one or more acquisition features associated with the user included in the dataset, information indicating one or more reasons for the user desiring to obtain a first item. As described herein, the computing device may be embodied as computing device 100, server computing system 300, or combinations thereof.

For example, in the computing system 4100 of FIG. 4, the item recommendation application 4120 may be configured to implement the one or more machine-learned models 4122 to determine, based on one or more acquisition features associated with the user which are stored in the recommendation data store 4140, information indicating one or more reasons for the user desiring to obtain an item. As an example, the computing device or an external computing device may be configured to automatically perform the method 2200, such that a recommendation output may be provided without a query from the user but in response to some user activity (e.g., in response to a user visiting a certain webpage, in response to a user utilizing a certain application on their smartphone or computer, etc.), or may be provided proactively independently of a user action (e.g., sending a message, notification, e-mail, etc., with the recommendation). For example, the one or more machine-learned models 4122 may request or retrieve information regarding reasons a user acquired parts for a vehicle the user owned from the recommendation data store 4140, and the one or more machine-learned models 4122 may determine, based on acquisition reasons associated with the user and related to the acquisition of parts for a vehicle (e.g., an Alpine Electronics X110-SLV touch screen), that the user valued “sound quality and performance in their vehicle systems.” The one or more machine-learned models 4122 can be configured to determine (predict) that the user desires to obtain or acquire parts for their vehicle (e.g., a Chevrolet Silverado truck) which “improve the performance of their Chevrolet Silverado truck”.

At operation 2220 the method 2200 includes the computing device providing, for presentation to the user, a recommendation related to a second item, based on the information indicating the one or more reasons for the user desiring to obtain the first item and one or more experiential features included in the dataset relating to the second item.

For example, in the computing system 4100 of FIG. 4, the item recommendation application 4120 may be configured to implement the one or more machine-learned models 4122 to provide the recommendation output 4150 which recommends the second item, based on the information indicating the one or more reasons for the user desiring to obtain the first item and one or more experiential features included in the dataset relating to the second item.

Extending the example described with respect to operation 2210, the information indicating the one or more reasons for the user desiring to obtain the first item (e.g., the Alpine Electronics X110-SLV touch screen) may include the user desiring to improve the performance of their Chevrolet Silverado truck. The one or more machine-learned models 4122 may be configured to provide the recommendation output 4150 of recommending a second item (e.g., a Pedal Commander throttle response controller PC65) for the user's vehicle that can improve the performance of the user's vehicle and which is also rated positively based on experiential features concerning the second item that are stored in the recommendation data store 4140. In some implementations, the recommendation output 4150 is further based on reviews by other users of the second item, such that highly rated items that also satisfy a user's motivational reasons for obtaining another item (e.g., in the same genre or category), as determined at operation 2210 based on the acquisition features associated with the user (e.g., associated with a user profile) stored in the recommendation data store 4140. In some implementations, the one or more machine-learned models 4122 may be configured to weight the information indicating the one or more reasons for the user desiring to obtain the second item (which can be inferred from the reasons for obtaining the first item as determined at operation 2320) and weight one or more experiential features included in the dataset relating to a plurality of other items, to determine the second item to recommend (e.g., based on the highest priority item according to the assigned weights). For example, an item that would satisfy a user's need for obtaining a part for improving the performance of their vehicle which is highly rated (e.g., five stars out of five), would be recommended over another item that would also satisfy the user's need for obtaining a part for improving the performance of their vehicle which is less highly rated (e.g., four stars out of five). For example, an item that would satisfy a user's need for obtaining a part for improving the performance of their vehicle which is highly rated (e.g., five stars out of five), would be recommended over another item that would satisfy most but not all of the user's need for obtaining a part for improving the performance of their vehicle and which is also highly rated (e.g., five stars out of five). Determining the degree to which an item would match a user's reason for obtaining an item can include determining the degree to which the acquisition reasons associated with the user for the second item match acquisition features associated with the item. For example, if a user's need is to have a car part that improves the performance of their vehicle and the user also values obtaining parts within two days, the one or more machine-learned models 4122 may be configured to determine whether a candidate item satisfies some or all of the criteria specified by the acquisition features associated with the user. The recommendation data store 4140 can correspond to the recommendation data store 3150 of FIG. 3, for example. The one or more machine-learned models 4122 can correspond to the one or more machine-learned models 3122 of FIG. 3, for example.

Referring to FIG. 2C, at operation 2310 the method 2300 includes a computing device receiving a query related to a second item from a user. For example, the query may be a search by a user for a particular item. As described herein, the computing device may be embodied as computing device 100, server computing system 300, or combinations thereof.

For example, in the computing system 4100 of FIG. 4, the item recommendation application 4120 may receive the query 4110. The query 4110 may correspond to a query from a user, from the computing device, or from an external computing device, which requests a recommendation for a particular item (e.g., a second item).

At operation 2320 the item recommendation application 4120 (e.g., the one or more machine-learned models 422) may be configured to determine, based on the one or more acquisition features associated with the user included in the dataset, information indicating one or more reasons for the user desiring to obtain a first item.

For example, similar to the example of FIG. 2B, the one or more machine-learned models 4122 may request or retrieve information regarding reasons a user acquired parts for a vehicle the user owned from the recommendation data store 4140, and the one or more machine-learned models 4122 may determine, based on acquisition reasons associated with the user and related to the acquisition of parts for a vehicle (e.g., an Alpine Electronics X110-SLV touch screen), that the user valued “sound quality and performance in their vehicle systems.” The one or more machine-learned models 4122 can be configured to determine (predict) that the user desires to obtain or acquire parts for their vehicle (e.g., a Chevrolet Silverado truck) which “improve the performance of their Chevrolet Silverado truck”.

At operation 2330 the method 2300 includes the computing device providing, for presentation to the user, a recommendation related to the second item, based on the information indicating the one or more reasons for the user desiring to obtain the first item and one or more experiential features included in the dataset relating to the second item. For example, operation 2330 may be similar to operation 2220 of FIG. 2B.

For example, in the computing system 4100 of FIG. 4, the item recommendation application 4120 may be configured to implement the one or more machine-learned models 4122 to provide the recommendation output 4150 which recommends the second item, based on the information indicating the one or more reasons for the user desiring to obtain the first item and one or more experiential features included in the dataset relating to the second item.

Extending the example described with respect to operation 2320, the information indicating the one or more reasons for the user desiring to obtain the first item (e.g., the Alpine Electronics X110-SLV touch screen) may include the user desiring to improve the performance of their Chevrolet Silverado truck. The one or more machine-learned models 4122 may be configured to provide the recommendation output 4150 of recommending a second item (e.g., a Pedal Commander throttle response controller PC65) for the user's vehicle that can improve the performance of the user's vehicle and which is also rated positively based on experiential features concerning the second item that are stored in the recommendation data store 4140. In some implementations, the recommendation output 4150 is further based on reviews (feedback) by other users of the second item, such that highly rated items that also satisfy a user's motivational reasons for obtaining another item (e.g., in the same genre or category), as provided for in the query 4110 at operation 2310 based on the acquisition features associated with the user (e.g., a user profile) stored in the recommendation data store 4140. In some implementations, the one or more machine-learned models 4122 may be configured to weight the information indicating the one or more reasons for the user desiring to obtain the second item (which can be inferred from the reasons for obtaining the first item as determined at operation 2320) and weight one or more experiential features included in the dataset relating to a plurality of other items, to determine the second item to recommend (e.g., based on the highest priority item according to the assigned weights). For example, an item that would satisfy a user's need for obtaining a part for improving the performance of their vehicle which is highly rated (e.g., five stars out of five), would be recommended over another item that would also satisfy the user's need for obtaining a part for improving the performance of their vehicle which is less highly rated (e.g., four stars out of five). For example, an item that would satisfy a user's need for obtaining a part for improving the performance of their vehicle which is highly rated (e.g., five stars out of five), would be recommended over another item that would satisfy most but not all of the user's need for acquiring a part for improving the performance of their vehicle and which is also highly rated (e.g., five stars out of five). Determining the degree to which an item would match a user's reason for obtaining an item can include determining the degree to which the acquisition reasons associated with the user for the second item match acquisition features associated with the item. For example, if a user's need is to have a car part that improves the performance of their vehicle and the user values obtaining parts within two days, the one or more machine-learned models 4122 may be configured to determine whether a candidate item satisfies some or all of the criteria specified by the acquisition features associated with the user. The recommendation data store 4140 can correspond to the recommendation data store 3150 of FIG. 3, for example. The one or more machine-learned models 4122 can correspond to the one or more machine-learned models 3122 of FIG. 3, for example.

As shown in FIG. 4, the one or more machine-learned models 4122 may also receive as another input the item information 4130 (e.g., as part of the query 4110 or separately). The item information 4130 can include information regarding an item that a user is interested in (e.g., the name of an item, a category of an item, etc.). For example, the item information 4130 can include information which is descriptive of the item (e.g., technical specifications regarding the item, brand information, cost information, availability information, identification information, compliance or legal information, durability information, appearance or aesthetic information, rating information, etc.). For example, the query 4110 and item information 4130 could be an input such as “smartphone with free shipping for teenager”, where the item information 4130 could correspond to “smartphone” and “free shipping” and the query 4110 portion could denote that the item is for a teenager. Therefore, in some implementations the query 4110 may also include acquisition features relating to the second item and the one or more machine-learned models 4122 may be configured to consider as an input acquisition features associated with the user relating to the second item which are included in the query 4110 and acquisition features associated with the user relating to the first item which are included in the recommendation data store 4140.

In some implementations, the method 2100 of FIG. 2A may be performed (e.g., in real-time) in conjunction with the method 2200 of FIG. 2B or the method 2300 of FIG. 2C. As an example, in response to receiving a query from a user for an item, the item recommendation application 3120 may be configured to (e.g., automatically) implement the one or more machine-learned models 3122 to determine (e.g., in real-time) the one or more acquisition features 3124 associated with the user and the one or more experiential features 3126 related to the item (or related items), as described according to the method 2100 of FIG. 2A. Based on the one or more acquisition features 3124 associated with the user and the one or more experiential features 3126 related to the item (or related items), the one or more machine-learned models 4122 may be configured to (e.g., in real-time) generate the recommendation output 4150. For example, if the user inputs a query such as “smartphone with free shipping for teenager”, the one or more machine-learned models 3122 can determine (e.g., in real-time) the one or more acquisition features 3124 associated with the user (e.g., the user values large screens, camera features, and is purchasing a smartphone for a teenager) and the one or more experiential features 3126 related to the item or related items (e.g., based on reviews of smartphones). The one or more machine-learned models 4122 may be configured to (e.g., in real-time) generate the recommendation output 4150 (e.g., a Google Pixel 8) based on the one or more acquisition features 3124 associated with the user and the one or more experiential features 3126 related to smartphones.

As another example, in response to a predetermined condition or trigger event occurring, the item recommendation application 3120 may be configured to (e.g., automatically) implement the one or more machine-learned models 3122 to determine (e.g., in real-time) the one or more acquisition features 3124 associated with the user and the one or more experiential features 3126 related to the item (or related items), as described according to the method 2100 of FIG. 2A. For example, the predetermined condition or trigger event can include at least one of a user requesting to access content via a particular website or a particular application, receiving an instruction or task to send or transmit a message or notification to a user, determining a user has entered a particular geographic location, determining a predetermined duration of time has elapsed, determining a particular context has been satisfied (e.g., the user has engaged in a particular type of activity), etc. Based on the one or more acquisition features 3124 associated with the user and the one or more experiential features 3126 related to the item (or related items), the one or more machine-learned models 4122 may be configured to (e.g., in real-time) generate the recommendation output 4150. For example, the one or more machine-learned models 3122 can determine (e.g., in real-time) one or more acquisition features 3124 associated with the user based on prior reviews of other items by the user (e.g., based on a review of a navigation receiver for their vehicle it is determined the user values improving the performance of their vehicle) and the one or more experiential features 3126 related to the item or related items (e.g., based on reviews of various components of a vehicle associated with the user). The one or more machine-learned models 4122 may be configured to (e.g., in real-time) generate the recommendation output 4150 (e.g., a recommendation of a fuel additive product that would improve the performance of the user's vehicle) based on the one or more acquisition features 3124 associated with the user and the one or more experiential features 3126 related to components of the vehicle associated with the user. For example, the recommendation can be provided for presentation to the user visually (e.g., in an e-mail, as an image on a web page, etc.) and/or through audio (e.g., via a speaker).

In some implementations, the item recommendation application 3120 and the item recommendation application 4120 may be embodied as a single application or may be embodied as distinct applications. Likewise, the one or more machine-learned models 3122 and the one or more machine-learned models 4122 may be embodied as part of the same model or may be embodied as distinct models.

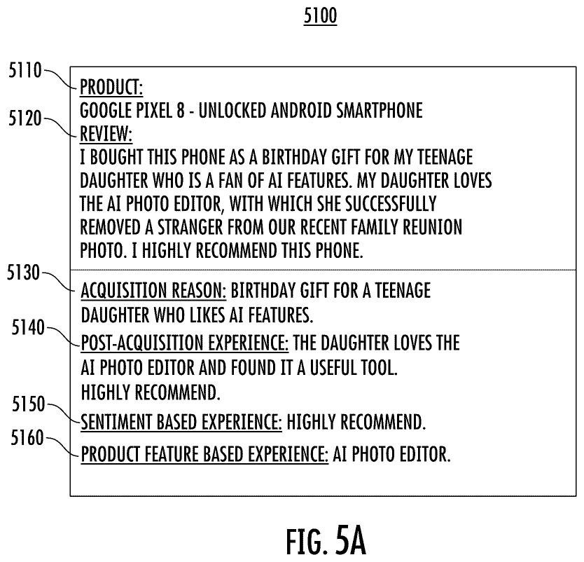

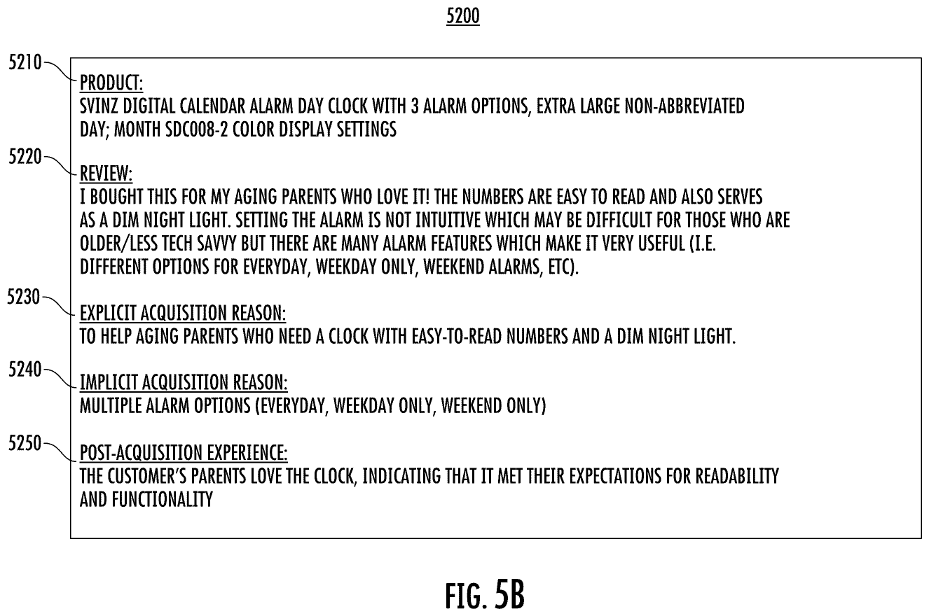

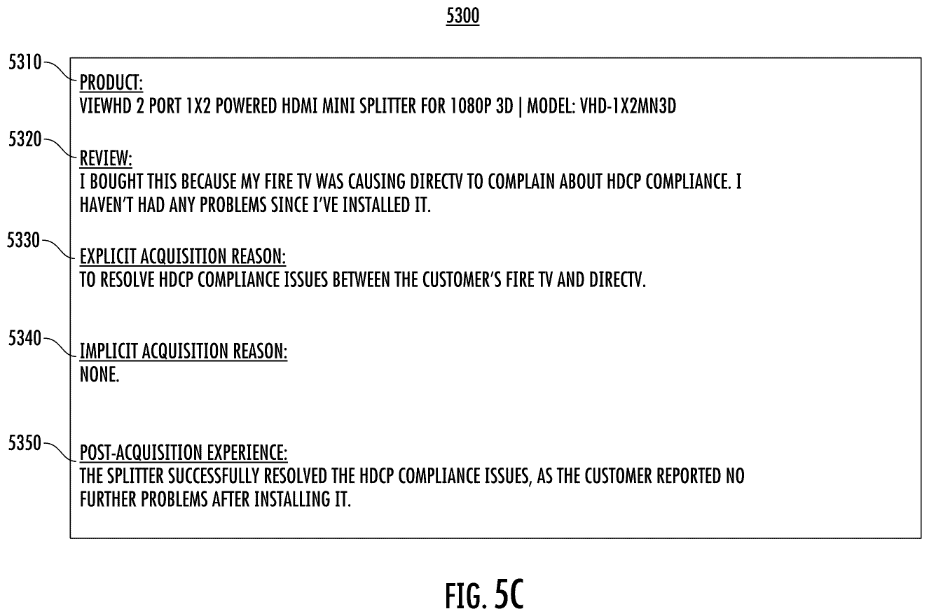

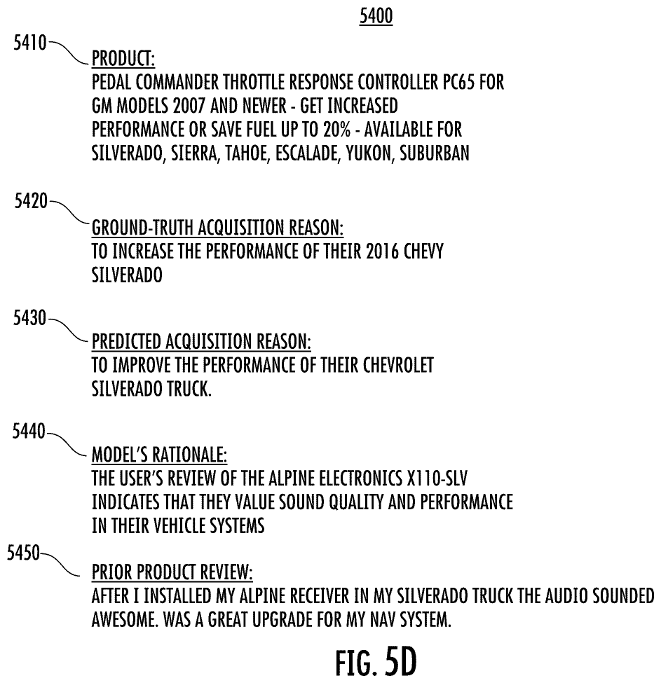

FIGS. 5A-5D are example dataset results obtained by implementing one or more machine-learned models, according to one or more example embodiments of the disclosure.

The example 5100 illustrated in FIG. 5A compares the results of existing methods with results of the methods disclosed herein. Referring to FIG. 5A, the example 5100 indicates product information 5110 corresponding to a Google Pixel 8 and content information 5120 of a review regarding the product. For example, the item recommendation application 3120 (e.g., the one or more machine-learned models 3122) may be configured to process a plurality of inputs including the product information 5110 and the content information 5120 to generate acquisition reasons 5130 which indicate reasons why a user was motivated to obtain an item before interacting with the item (e.g., as a birthday gift for a teenage daughter who likes AI features), and post-acquisition reasons 5140 which includes feedback indicating whether the user was satisfied with their experience with the item (the daughter loved the AI photo editor, found it useful, and highly recommended the item).

In contrast to the disclosed method, the example 5100 illustrated in FIG. 5A indicates existing methods provide less information and merely reflect an overall post-experience sentiment 5150 (e.g., “highly recommend”) and post-experience feedback 5160 concerning features of the product (e.g., “AI photo editor”). Therefore, existing methods lack information concerning reasons for a user's initial decision to obtain an item.

The example 5200 illustrated in FIG. 5B demonstrates example results of the methods disclosed herein. Referring to FIG. 5B, the example 5200 indicates product information 5210 corresponding to a SVINZ Digital Calendar Alarm Day Clock and content information 5220 of a review regarding the product. For example, the item recommendation application 3120 (e.g., the one or more machine-learned models 3122) may be configured to process a plurality of inputs including the product information 5210 and the content information 5220 to generate acquisition reasons (acquisition features) which indicate reasons why a user was motivated to obtain an item before interacting with the item. In the example of FIG. 5B, the acquisition reasons (acquisition features) can include explicit acquisition features 5230 (e.g., help aging parents who need a clock with easy-to-read numbers and a dim night light) and implicit acquisition features 5240 (e.g., multiple alarm options), and post-acquisition reasons 5250 which includes feedback indicating whether the user was satisfied with their experience with the item (e.g., customer's parents love the clock, indicating that it met their expectations for readability and functionality). For example, the explicit acquisition features 5230 can be directly obtained from the content information 5220 while the implicit acquisition features 5240 can be inferred from the product information 5210 and/or content information 5220.

The example 5300 illustrated in FIG. 5C demonstrates example results of the methods disclosed herein. Referring to FIG. 5C, the example 5300 indicates product information 5310 corresponding to a ViewHD 2 Port 1x2 Powered HDMI Mini Splitter and content information 5320 of a review regarding the product. For example, the item recommendation application 3120 (e.g., the one or more machine-learned models 3122) may be configured to process a plurality of inputs including the product information 5310 and the content information 5320 to generate acquisition reasons (acquisition features) which indicate reasons why a user was motivated to obtain an item before interacting with the item. In the example of FIG. 5C, the acquisition reasons (acquisition features) can include explicit acquisition features 5330 (e.g., resolve HDCP compliance issues between the customer's Fire TV and DirecTV) and implicit acquisition features 5340 (e.g., none in this example), and post-acquisition reasons 5350 which includes feedback indicating whether the user was satisfied with their experience with the item (e.g., splitter successfully resolved the HDCP compliance issues, as the customer reported no further problems after installing it). For example, the explicit acquisition features 5330 can be directly obtained from the content information 5320 while the implicit acquisition features 5340 can be inferred (if applicable) from the product information 5310 and/or content information 5320.

The example 5400 illustrated in FIG. 5D demonstrates example results of the methods disclosed herein. Referring to FIG. 5D, the example 5400 indicates product information 5410 corresponding to a Pedal Commander throttle response controller PC65 and content information 5450 of a review regarding another product previously purchased. For example, the item recommendation application 3120 (e.g., the one or more machine-learned models 3122) may be configured to process a plurality of inputs including the product information 5410 and the content information 5450 concerning a prior product, to generate (predict) acquisition reasons (acquisition features) 5430 which indicate reasons why a user may be motivated to obtain an item corresponding to product information 5410, before interacting with the item. In the example of FIG. 5D, the acquisition reasons (acquisition features) can include explicit acquisition features and implicit acquisition features. In the example of FIG. 5D, the predicted acquisition reasons predicted by the one or more machine-learned models 3122 include to “improve the performance of their Chevrolet Silverado truck.” The example 5400 further includes ground-truth reasons 5420 (“To increase the performance of their 2016 Chevy Silverado”). Therefore, it can be seen that the predicted acquisition reasons substantially correspond to the ground truth reasons in the example of FIG. 5D. Further, the one or more machine-learned models 3122 may be configured to generate a rationale for determining the one or more acquisition features. In the example of FIG. 5D, the example 5400 includes rationale information 5440 explaining the support for concluding that a user's reason for purchasing the Pedal Commander throttle response controller PC65 may be for improving the performance of their truck (e.g., based on the content of the prior product review which indicates the user values sound quality and performance in their vehicle systems).

In some implementations, the predicted reasons (predicted acquisition features) may be stored in the recommendation data store 4140 (and associated with the user and the particular item and/or category or type of item). For example, the one or more machine-learned models 4122 may be configured to determine, based on the one or more acquisition features associated with the user included in the recommendation data store 4140, information indicating one or more reasons for the user desiring to obtain a first item (e.g., the Alpine Electronics X110-SLV receiver). For example, the one or more machine-learned models 4122 may be configured to determine, based on the one or more acquisition features associated with the user included in the recommendation data store 4140, information indicating one or more reasons (e.g., sound quality and improved vehicle system performance) for the user desiring to obtain the Alpine Electronics X110-SLV receiver.

For example, the one or more machine-learned models 4122 may be configured to provide, for presentation to the user, a recommendation related to a second item (e.g., the Pedal Commander throttle response controller PC65), based on the information indicating the one or more reasons for the user desiring to obtain the first item (e.g., the Alpine Electronics X110-SLV receiver) and one or more experiential features included in the dataset relating to the second item. For example, the one or more machine-learned models 4122 may be configured to present the Pedal Commander throttle response controller PC65 as a recommendation to a user based on the acquisition features associated with the user relating to the Alpine Electronics X110-SLV receiver and post-acquisition information (experiential features) from one or more user reviews associated with the Pedal Commander throttle response controller PC65.

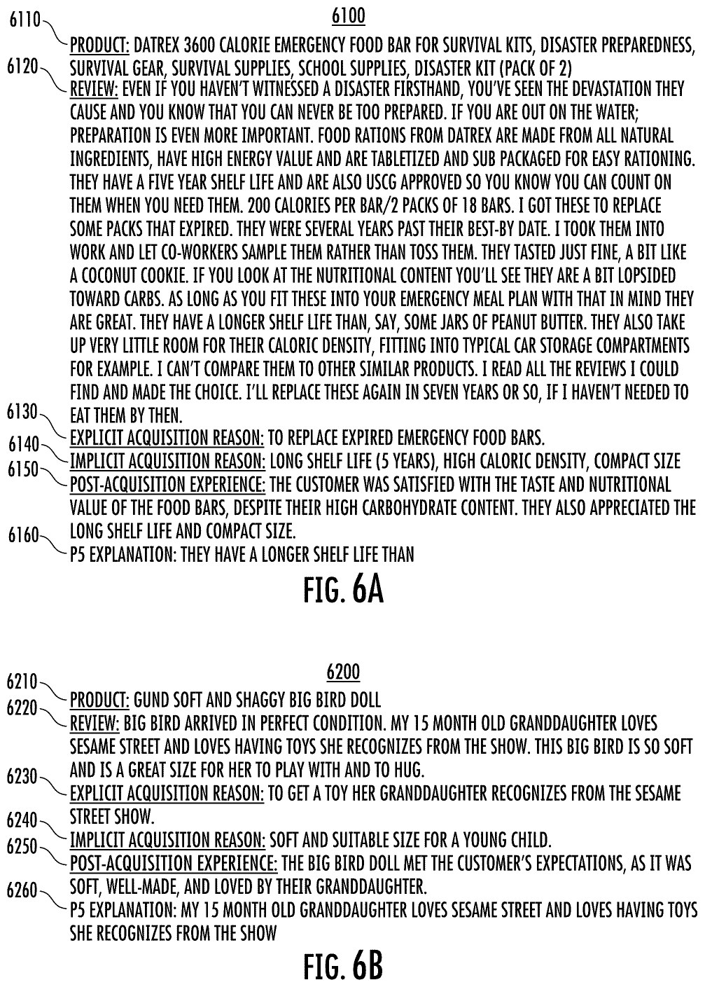

FIGS. 6A-6B illustrate example dataset results obtained by implementing one or more machine-learned models compared to other dataset results obtained from other methods, according to one or more example embodiments of the disclosure. For example, the example 6100 illustrated in FIG. 6A compares the results of an existing method (P5 method) with results of the methods disclosed herein. Referring to FIG. 6A, the example 6100 indicates product information 6110 corresponding to a Datrex 3600 Calorie Emergency Food Bar and content information 6120 of a review regarding the item. For example, the item recommendation application 3120 (e.g., the one or more machine-learned models 3122) may be configured to process a plurality of inputs including the product information 6110 and the content information 6120 to generate acquisition reasons which indicate reasons why a user was motivated to obtain an item before interacting with the item (which include explicit acquisition reasons 6130 and implicit acquisition reasons 6140), and post-acquisition reasons 6150 which include feedback indicating whether the user was satisfied with their experience with the item. In contrast to the disclosed method, the example 6100 illustrated in FIG. 6A indicates an existing method (P5 method) which extracts sentences containing product features as explanations and covers three particular product categories. The P5 explanation 6160 is limited to product features (“longer shelf life”) derived from post-acquisition feedback and lacks information concerning reasons for a user's initial decision to obtain an item.

For example, the example 6200 illustrated in FIG. 6B compares the results of an existing method (P5 method) with results of the methods disclosed herein. Referring to FIG. 6B, the example 6200 indicates product information 6210 corresponding to a Gund Soft and Shaggy Big Bird Doll and content information 6220 of a review regarding the item. For example, the item recommendation application 3120 (e.g., the one or more machine-learned models 3122) may be configured to process a plurality of inputs including the product information 6210 and the content information 6220 to generate acquisition reasons which indicate reasons why a user was motivated to obtain an item before interacting with the item (which include explicit acquisition reasons 6230 and implicit acquisition reasons 6240), and post-acquisition reasons 6250 which include feedback indicating whether the user was satisfied with their experience with the item.

In contrast to the disclosed method, the example 6200 illustrated in FIG. 6B indicates an existing method (P5 method) which extracts sentences containing product features as explanations and covers three particular product categories. The P5 explanation 6260 is derived from post-acquisition feedback indicating the user's granddaughter loves Sesame Street and toys from the show.

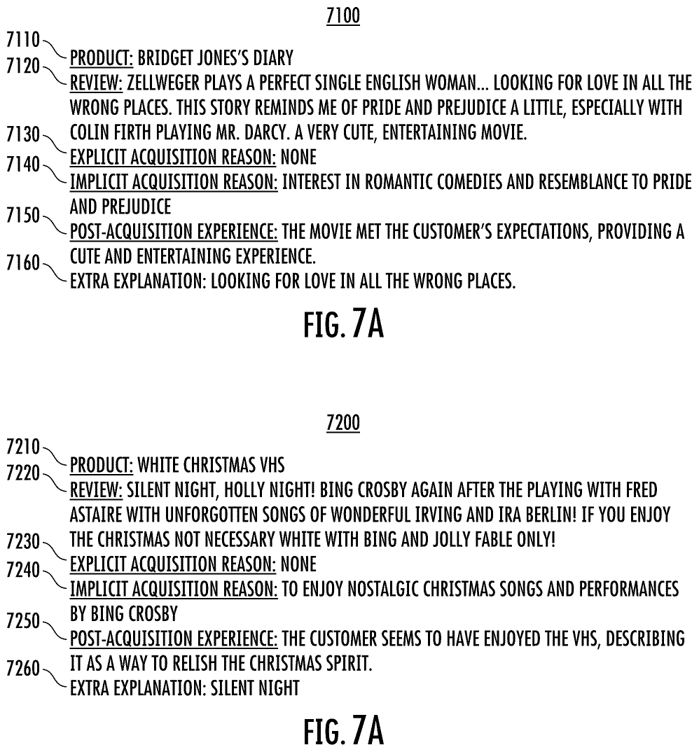

FIGS. 7A-7B illustrate example dataset results obtained by implementing one or more machine-learned models compared to other dataset results obtained from other methods, according to one or more example embodiments of the disclosure. For example, the example 7100 illustrated in FIG. 7A compares the results of an existing method (EXTRA method) with results of the methods disclosed herein. Referring to FIG. 7A, the example 7100 indicates product information 7110 corresponding to the movie Bridget Jones's Diary and content information 7120 of a review regarding the item. For example, the item recommendation application 3120 (e.g., the one or more machine-learned models 3122) may be configured to process a plurality of inputs including the product information 7110 and the content information 7120 to generate acquisition reasons which indicate reasons why a user was motivated to obtain an item before interacting with the item (which include explicit acquisition reasons 7130 and implicit acquisition reasons 7140), and post-acquisition reasons 7150 which include feedback indicating whether the user was satisfied with their experience with the item. In contrast to the disclosed method, the example 7100 illustrated in FIG. 7A indicates an existing method (EXTRA method) which utilizes frequently used phrases and focuses on particular movies and television reviews. The EXTRA explanation 7160 is limited to frequently used phrases (“Looking for love in all the wrong places”) derived from post-acquisition feedback after the user has watched the movie and lacks information concerning reasons for a user's initial decision to obtain an item.

For example, the example 7200 illustrated in FIG. 7B compares the results of an existing method (EXTRA method) with results of the methods disclosed herein. Referring to FIG. 7B, the example 7200 indicates product information 7210 corresponding to the movie White Christmas and content information 7220 of a review regarding the item. For example, the item recommendation application 3120 (e.g., the one or more machine-learned models 3122) may be configured to process a plurality of inputs including the product information 7210 and the content information 7220 to generate acquisition reasons which indicate reasons why a user was motivated to obtain an item before interacting with the item (which include explicit acquisition reasons 7230 and implicit acquisition reasons 7240), and post-acquisition reasons 7250 which include feedback indicating whether the user was satisfied with their experience with the item.

In contrast to the disclosed method, the example 7200 illustrated in FIG. 7B indicates an existing method (EXTRA method) which utilizes frequently used phrases and focuses on particular movies and television reviews. The EXTRA explanation 7260 is limited to frequently used phrases (“Silent night”) derived from post-acquisition feedback after the user has watched the movie and lacks information concerning reasons for a user's initial decision to obtain an item.

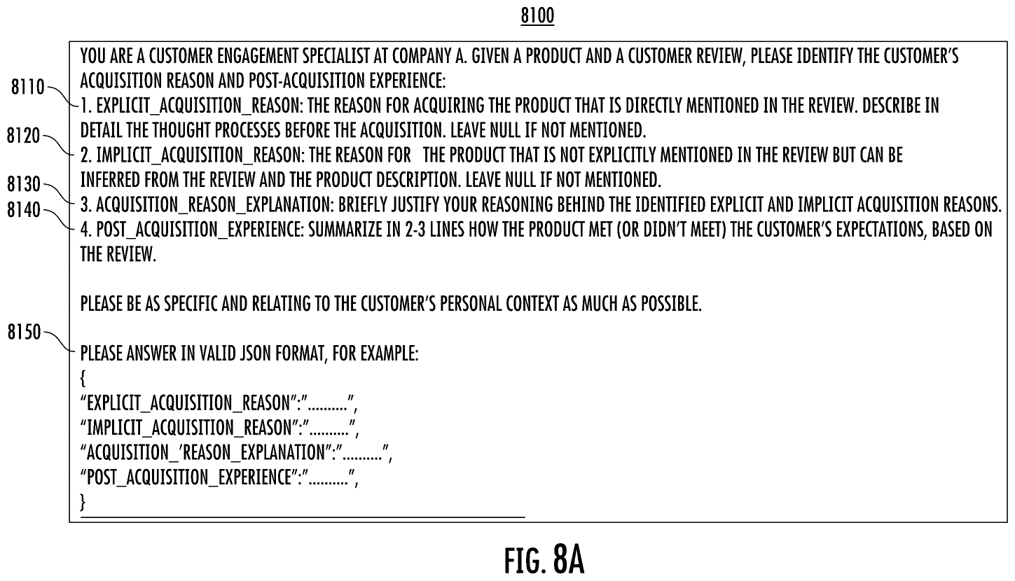

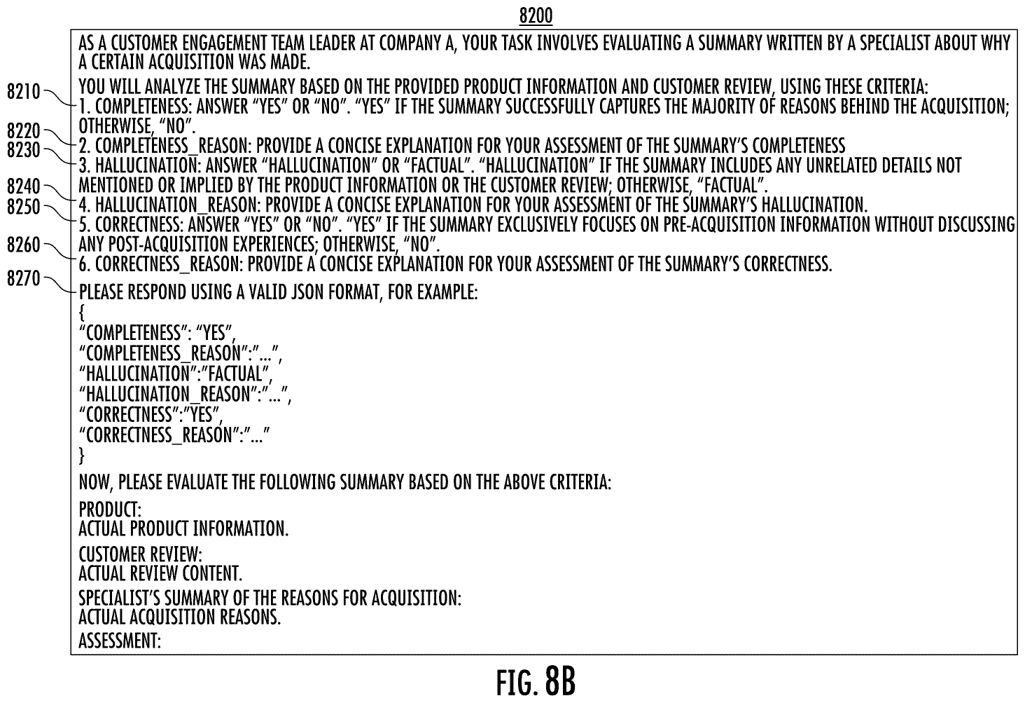

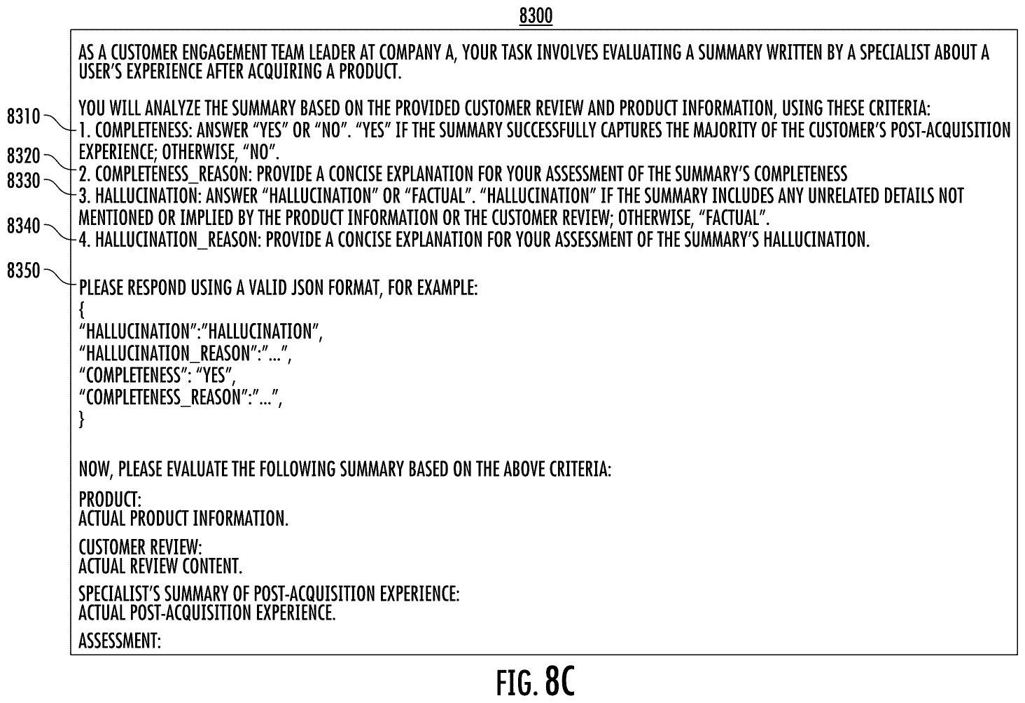

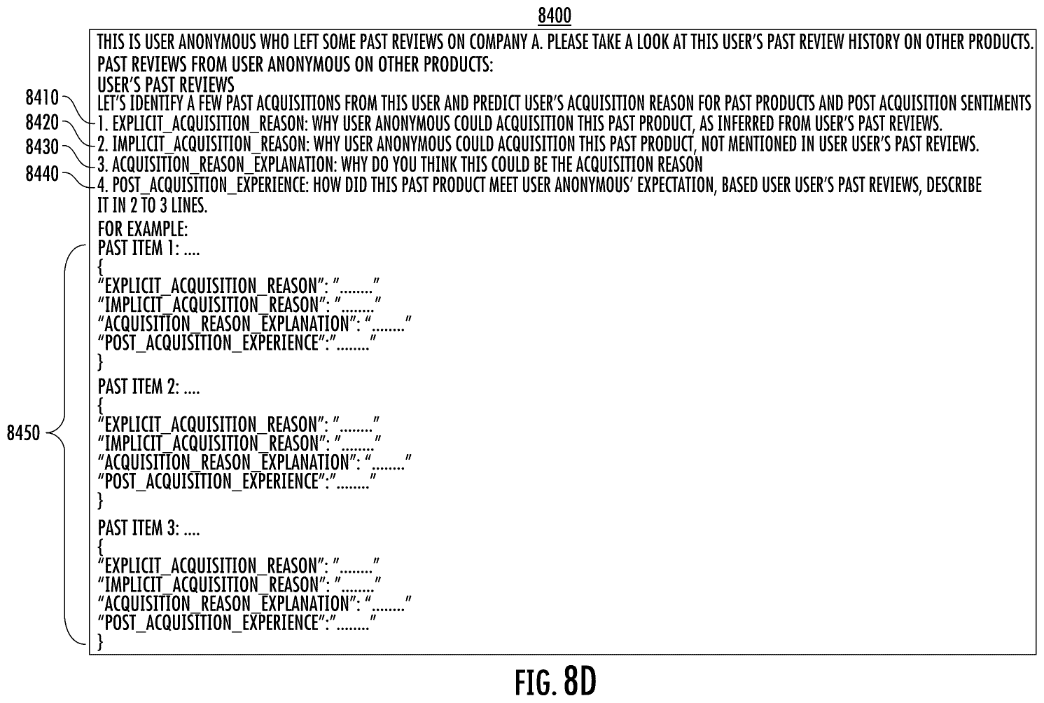

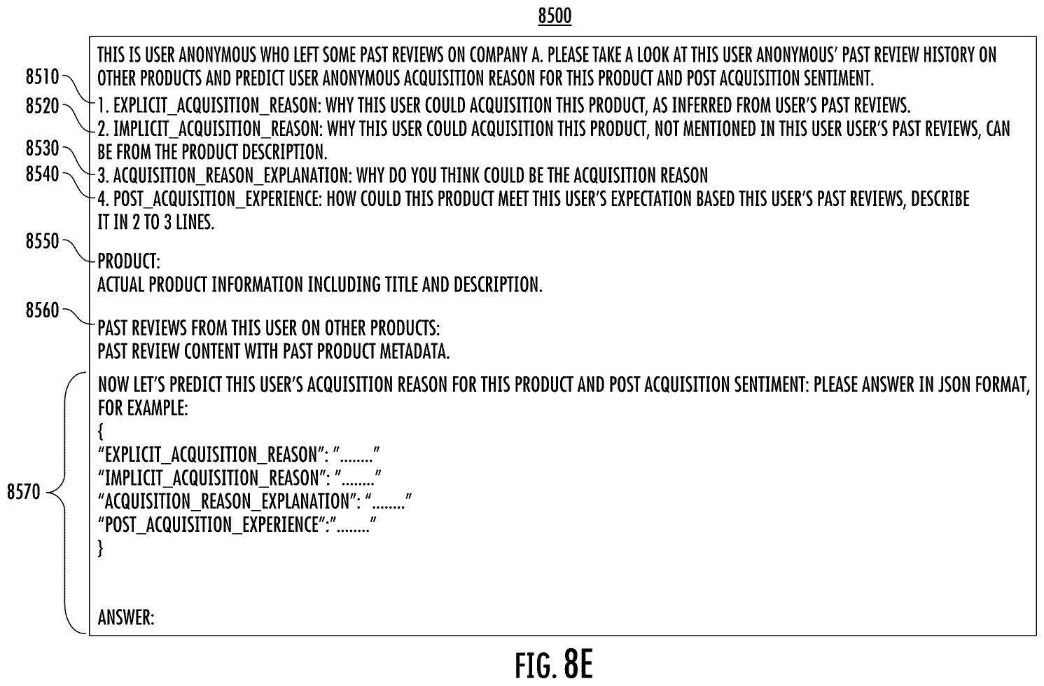

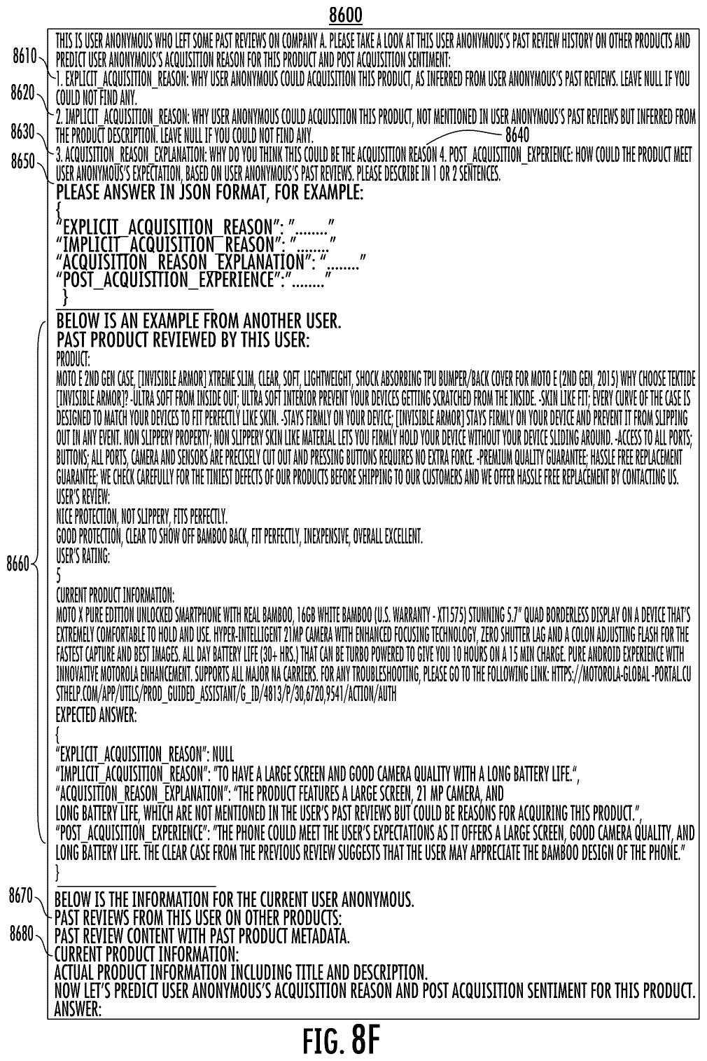

FIGS. 8A-8E illustrate example prompts for recommendation system tasks, according to one or more example embodiments of the disclosure. In some implementations, the computing device may be configured to provide a prompt to the item recommendation application 3120 (e.g., the one or more machine-learned models 3122) to determine one or more acquisition features 3124 associated with a user relating to a first item prior to the user interacting with the first item and to determine one or more experiential features 3126 relating to a first item or other items after the first item or other items have been experienced (interacted with). FIG. 8A illustrates an example prompt 8100 to the computing device relating to a task for generating acquisition features (reasons) and experiential features based on inputs including an item and a review of the item (e.g., by a user who has obtained the item and/or by other users). The prompt 8100 may include various instructions (e.g., parameters, definitions, etc.) for the one or more machine-learned models 3122 including first instructions 8110 for determining explicit acquisition features, second instructions 8120 for determining implicit acquisition features, third instructions 8130 for generating a rationale, fourth instructions 8140 for generating experiential features, and fifth instructions 8150 for utilizing a particular format for providing the output.

In some implementations, the computing device may be configured to provide a prompt to the item recommendation application 3120 (e.g., the one or more machine-learned models 3122) to evaluate an explanation or summary regarding the reasons a user decided to obtain an item (e.g., evaluating the validity or completeness of an explanation which includes one or more acquisition features 3124 associated with a user relating to a first item prior to the user interacting with the first item). FIG. 8B illustrates an example prompt 8200 to the computing device relating to a task for evaluating an explanation or summary regarding the reasons a user decided to obtain an item. The prompt 8200 may include instructions (e.g., parameters, definitions, etc.) for the one or more machine-learned models 3122 including first instructions 8210 for determining the completeness of an answer (explanation), second instructions 8220 for providing support regarding the evaluation of the completeness, third instructions 8230 for determining whether the answer (explanation) includes hallucinated details not mentioned or supported by item information in the item data store 360 or content information in the review data store 350, fourth instructions 8240 providing support regarding the evaluation of whether hallucinations occur in the explanation, fifth instructions 8250 for determining if the answer (explanation) correctly focuses only on information that relates to pre-acquisition motivational reasons, sixth instructions 8260 for providing support regarding the evaluation of the correctness of the evaluations, and seventh instructions 8270 for utilizing a particular format for providing the output.

In some implementations, the computing device may be configured to provide a prompt to the item recommendation application 3120 (e.g., the one or more machine-learned models 3122) to evaluate an explanation or summary regarding the satisfaction or dissatisfaction that a user has regarding the user's experience with the item after the user has interacted with the item (e.g., evaluating the validity or completeness of an explanation which includes one or more experiential features 3126 associated with a user relating to a first item after the user interacts with the first item). FIG. 8C illustrates an example prompt 8300 to the computing device relating to a task for evaluating an explanation or summary the satisfaction or dissatisfaction that a user has regarding the user's experience with the item after the user has interacted with the item. The prompt 8300 may include instructions (e.g., parameters, definitions, etc.) for the one or more machine-learned models 3122 including first instructions 8310 for determining the completeness of an answer (explanation), second instructions 8320 for providing support regarding the evaluation of the completeness, third instructions 8330 for determining whether the answer (explanation) includes hallucinated details not mentioned or supported by item information in the item data store 360 or content information in the review data store 350, fourth instructions 8340 providing support regarding the evaluation of whether hallucinations occur in the explanation, and fifth instructions 8350 for utilizing a particular format for providing the output.

In some implementations, the computing device may be configured to provide a prompt to the item recommendation application 3120 (e.g., the one or more machine-learned models 3122) to predict acquisition features (reasons) and experiential features based on inputs including prior reviews of a plurality of items (e.g., by a user who has interacted with various items) and to generate an explanation or summary regarding the reasons a user has decided to obtain each item and a summary regarding the satisfaction or dissatisfaction that a user has regarding the user's experience with each item after the user has interacted with the item. FIG. 8D illustrates an example prompt 8400 to the computing device relating to a task for predicting acquisition features (reasons) and experiential features. The prompt 8400 may include instructions (e.g., parameters, definitions, etc.) for the one or more machine-learned models 3122 including first instructions 8410 for determining explicit acquisition features associated with one or more reviews of an item, second instructions 8420 for determining implicit acquisition features associated with the item based on information not found in past reviews of the user, third instructions 8430 for determining a rationale for determining the explicit and acquisition features, and fourth instructions 8440 for determining experiential features relating to whether the item satisfied expectations of the user based on the reviews of the user. The example prompt 8400 further provides fifth instructions 8450 for utilizing a particular format for providing the output summarizing the explicit acquisition features, implicit acquisition features, rationale, and experiential features for each item.

In some implementations, the computing device may be configured to provide a prompt to the item recommendation application 3120 (e.g., the one or more machine-learned models 3122) to perform a task of generating an explanation for recommending an item to a user given information about a user and an item. FIG. 8D illustrates an example zero-shot prompt 8500 to the computing device relating to a task for generating an explanation for recommending an item to a user given information about a user and an item. The prompt 8500 may include instructions (e.g., parameters, definitions, etc.) for the one or more machine-learned models 3122 including first instructions 8510 for determining explicit acquisition features associated with a first item based on a first input including past reviews 8560 of other items and a second input including item information 8550 regarding the first item, second instructions 8520 for determining implicit acquisition features associated with the first item based on information not mentioned in prior reviews and item information 8550 regarding the first item, third instructions 8530 for determining a rationale for determining the explicit and acquisition features, and fourth instructions 8540 for determining experiential features relating to how the first item could satisfy expectations of the user based on inputs including the reviews of the user from past reviews 8560. The example prompt 8500 further provides fifth instructions 8570 for utilizing a particular format for providing the output summarizing the explicit acquisition features, implicit acquisition features, rationale, and experiential features for each item.

In some implementations, the computing device may be configured to provide a prompt to the item recommendation application 3120 (e.g., the one or more machine-learned models 3122) to perform a task of generating an explanation for recommending an item to a user given information about a user and an item, and an example of the task (e.g., a one-shot prompt). FIG. 8E illustrates an example one-shot prompt 8600 to the computing device relating to a task for generating an explanation for recommending an item to a user given information about a user and an item. The one-shot prompt 8600 may include instructions (e.g., parameters, definitions, etc.) for the one or more machine-learned models 3122 including first instructions 8610 for determining explicit acquisition features associated with a first item based on an example task 8660, a first input including past reviews 8670 of other items, and second input including item information 8680 regarding the first item, second instructions 8620 for determining implicit acquisition features associated with the first item based on the example task 8660, information not mentioned in prior reviews and item information 8680 regarding the first item, third instructions 8630 for determining a rationale for determining the explicit and acquisition features based on the example task 8660, and fourth instructions 8640 for determining experiential features relating to how the first item could satisfy expectations of the user based on inputs including the reviews of the user from past reviews 8670. The example prompt 8600 further provides fifth instructions 8650 for utilizing a particular format for providing the output summarizing the explicit acquisition features, implicit acquisition features, rationale, and experiential features for each item.

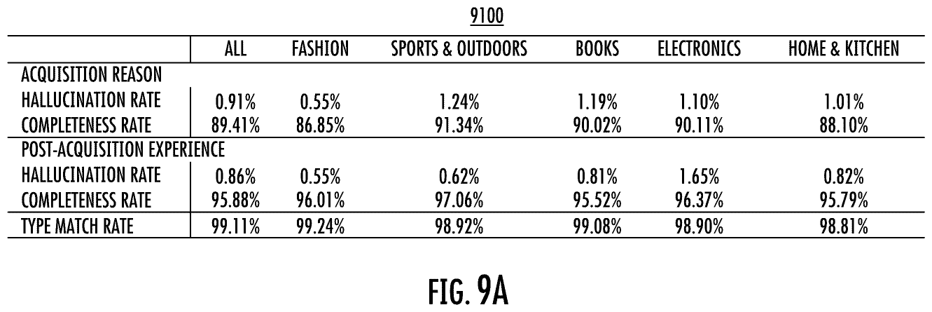

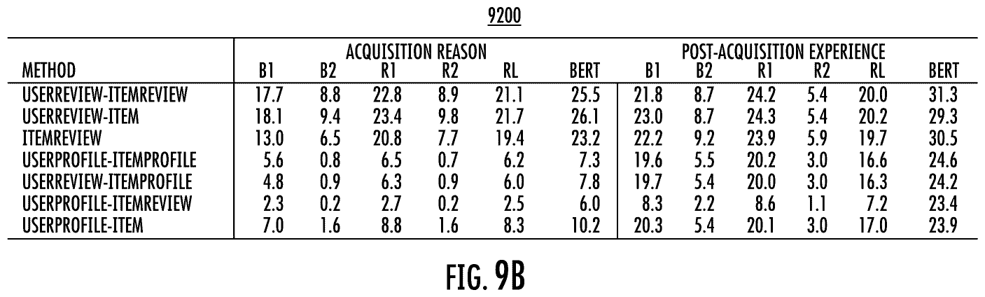

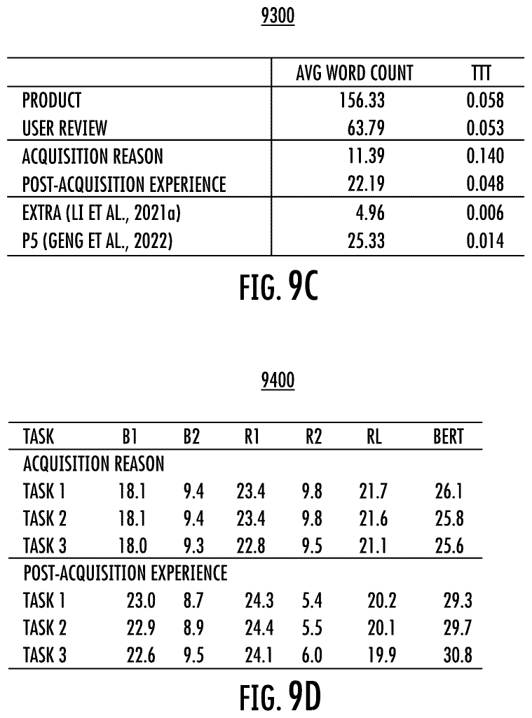

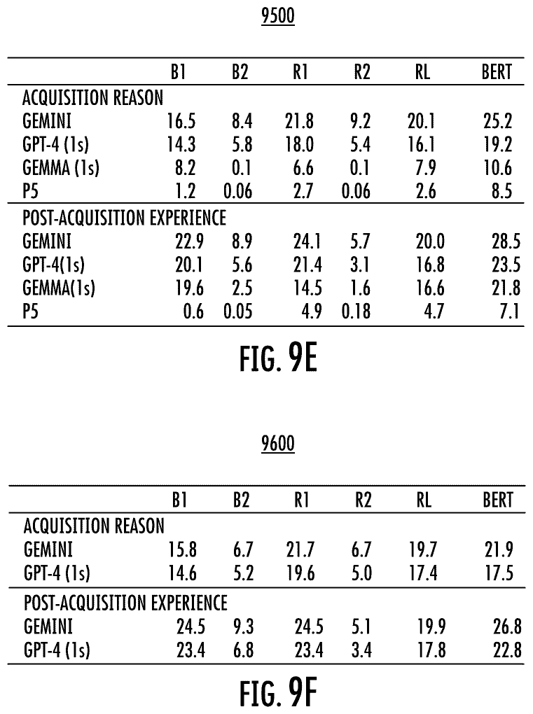

FIGS. 9A-9F illustrate example experimental results, according to one or more example embodiments of the disclosure. FIG. 9A includes a table 9100 which shows experimental results obtained via the one or more machine-learned models (e.g., one or more machine-learned models 3122) which are configured to evaluate (rate) the performance of explanations generated via the one or more machine-learned models (e.g., one or more machine-learned models 3122). Table 9100 reflects results across various product categories. As can be seen from table 9100, the one or more machine-learned models (e.g., one or more machine-learned models 3122) described herein have a low hallucination rate (e.g., 0.91% overall for acquisition features and 0.86% overall for experiential features) and rarely confuse the acquisition features with the experiential features (0.89%). Further, the one or more machine-learned models (e.g., one or more machine-learned models 3122) described herein have high completeness rates indicating high data quality.

FIG. 9B includes a table 9200 which shows experimental results obtained via the one or more machine-learned models (e.g., one or more machine-learned models 3122) which are configured to generate explanations including acquisition features and experiential features. In FIG. 9B, table 9200 includes results obtained using different user and item representations (e.g., (1) Item including the item title and description, (2) ItemReview additionally including past reviews of the item written by other users before the given user's acquisition of the item, and (3) ItemProfile which replaces past reviews with an LLM generated summary. Metrics which are used to measure the performance of the one or more machine-learned models include B/R/RL/BERT which denote metrics (e.g., lexical and similarity metrics) corresponding to BLEU, ROUGE, ROUGE-Lsum, BERTScore, respectively. As shown in table 9200, the one or more machine-learned models (e.g., one or more machine-learned models 3122) which have as inputs raw past reviews of the user and items with their metadata (UserReview+Item) are the most effective for both generation tasks (identifying acquisition features and experiential features).

FIG. 9C includes a table 9300 which shows linguistic characteristics of the dataset obtained via the methods described herein compared to other explanation datasets (EXTRA and P5). In FIG. 9C, table 9300 reflects that the explanation comprising the acquisition features and the experiential features have a larger type-to-token (TTT) score, indicating a higher lexical diversity compared to the explanations obtained via the EXTRA and P5 methods. Therefore, the methods described herein result in a more diverse and complete explanation regarding a user's reasons for obtaining an item and their review of the item after interacting with the item.

FIG. 9D includes a table 9400 which shows experimental results obtained via the one or more machine-learned models (e.g., one or more machine-learned models 3122) which are configured to generate explanations including acquisition features and experiential features, where the task formulation (prompt) for the one or more machine-learned models (e.g., one or more machine-learned models 3122) is varied. In FIG. 9D, table 9400 includes results obtained using a first task formulation (Task 1: generate an explanation for recommending an item to the user give information about the user and the item), a second task formation (Task 2: generate an explanation for why an item was recommended to the user given information about the user and the item and the user's ground-truth rating for the item), and a third task formulation (Task 3: generate an explanation for recommending an item as well as a prediction of the user's rating on the item given information about the user and the item). The experimental results of table 9400 indicate that indicates that the one or more machine-learned models (e.g., one or more machine-learned models 3122) exhibit robustness to variations in auxiliary information and tasks when operated in zero-shot settings.

FIG. 9E includes a table 9500 which shows experimental results obtained via the one or more machine-learned models (e.g., one or more machine-learned models 3122) which are configured to generate explanations including acquisition features and experiential features compared to other methods. The example results shown in table 9500 implement different models for implementing the methods described herein (e.g., Gemini Ultra in a zero-shot setup, GPT-4 Turbo with one-shot setup, Gemma-7B with one-shot setup, and P5) with respect to 1,000 randomly sampled reviews. In evaluating the different models, the Gemini Ultra model was used for generating the ground truth data. The results of table 9500 indicate that implementing the Gemini Ultra model outperformed the other models.

FIG. 9F includes a table 9600 which shows experimental results obtained via the one or more machine-learned models (e.g., one or more machine-learned models 3122) which are configured to generate explanations including acquisition features and experiential features compared to other methods. The example results shown in table 9600 implement different models for implementing the methods described herein (e.g., Gemini Ultra in a zero-shot setup, GPT-4 Turbo with one-shot setup, Gemma-7B with one-shot setup, and P5) with respect to 1,000 randomly sampled reviews. In evaluating the different models, the GPT-4 Turbo model was used for generating the ground truth data. The results of table 9600 indicate that implementing the Gemini Ultra model outperformed the other models. The results shown in FIGS. 9E and 9F consistently demonstrate Gemini's superior performance, regardless of the ground truth source.

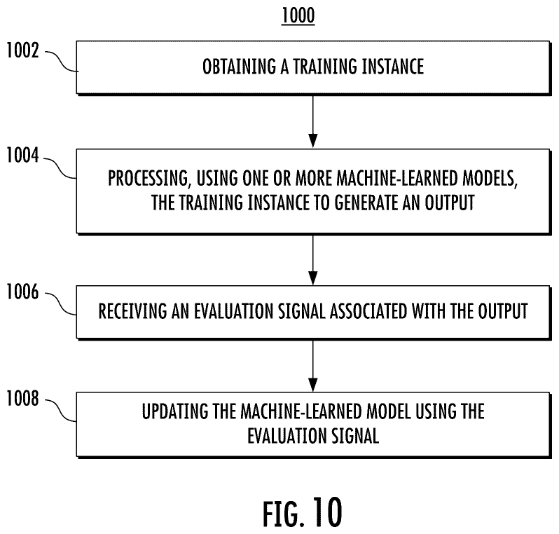

FIG. 10 depicts a flowchart of a method 1000 for training one or more machine-learned models according to aspects of the disclosure. For instance, an example machine-learned model can include one or more of a LLM, a generative machine-learned model, etc. For example, the one or more machine-learned models may be configured to implement the operations of FIGS. 2A-2C, of the item recommendation applications as described herein.

FIG. 10 is a flow chart diagram illustrating an example method for training a machine-learned model according to example implementations of aspects of the disclosure. One or more portion(s) of example method 1000 can be implemented by a computing system that includes one or more computing devices such as, for example, computing systems described with reference to the other drawings. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 10 is described with reference to elements/terms described with respect to other systems and drawings for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-learned Models

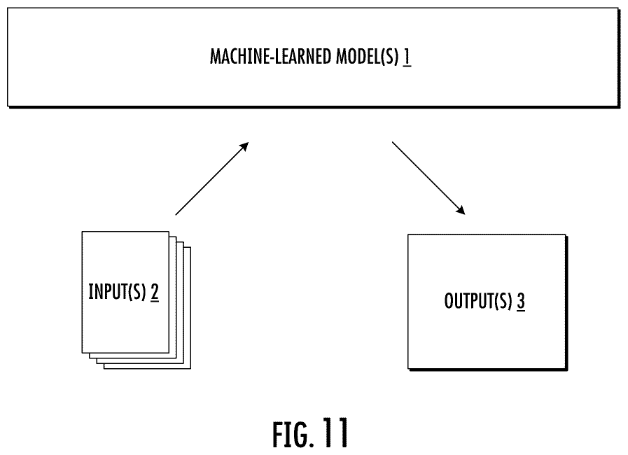

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the disclosure are not limited to those examples noted above.

### Example Machine-learned Sequence Processing Models

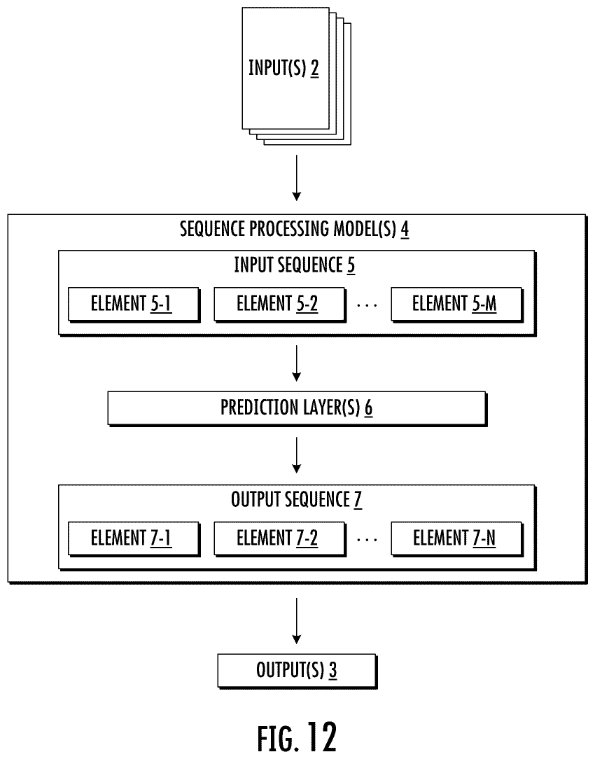

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

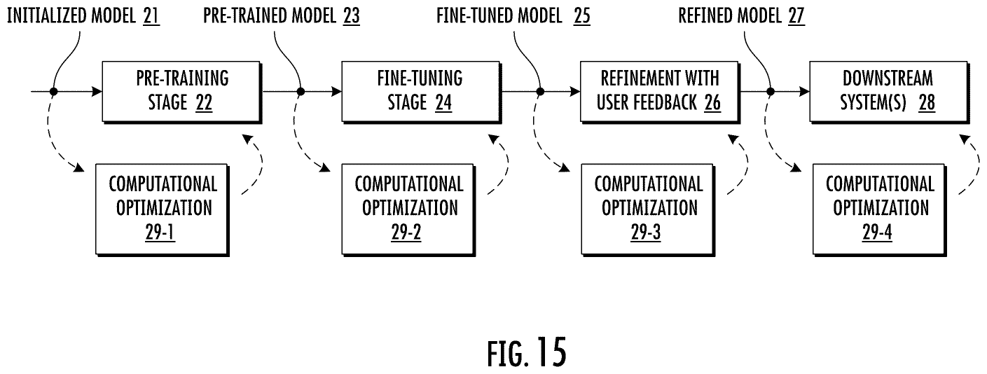

In general, arbitrary data types can be serialized and processed into input sequence 5. It is to be understood that element(s) 5-1, 5-2, . . . , 5-M depicted in FIG. 15 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

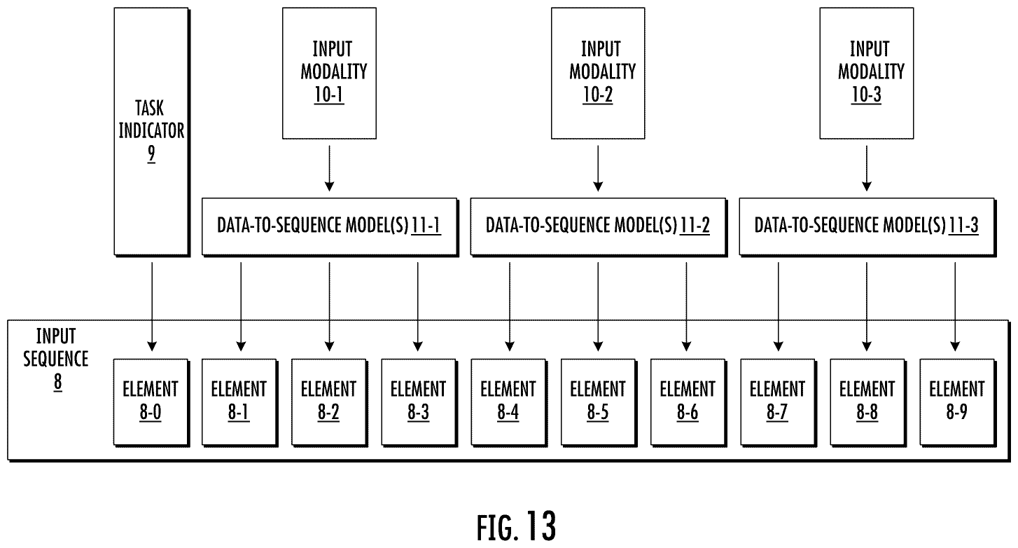

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

### Example Machine-learned Model Development Platform

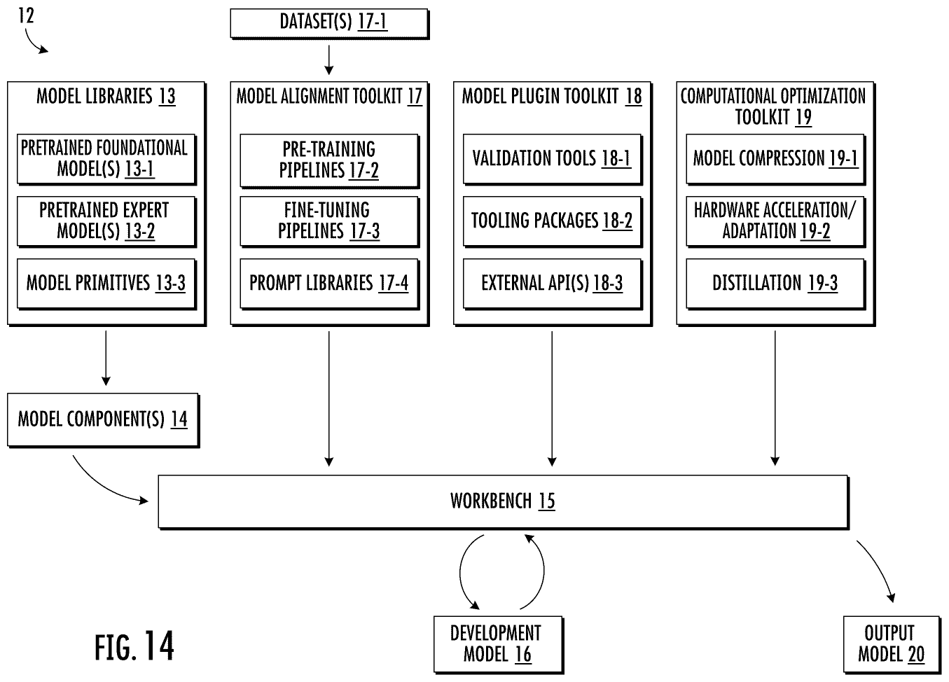

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data.

Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16.

Output model 20 can be a distilled, compressed, or otherwise optimized version of development model 16.

FIG. 15 is a block diagram of an example training flow for training a machine-learned development model 16. One or more portion(s) of the example training flow can be implemented by a computing system that includes one or more computing devices such as, for example, computing systems described with reference to the other drawings. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 15 is described with reference to elements/terms described with respect to other systems and drawings for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-learned Model Inference System

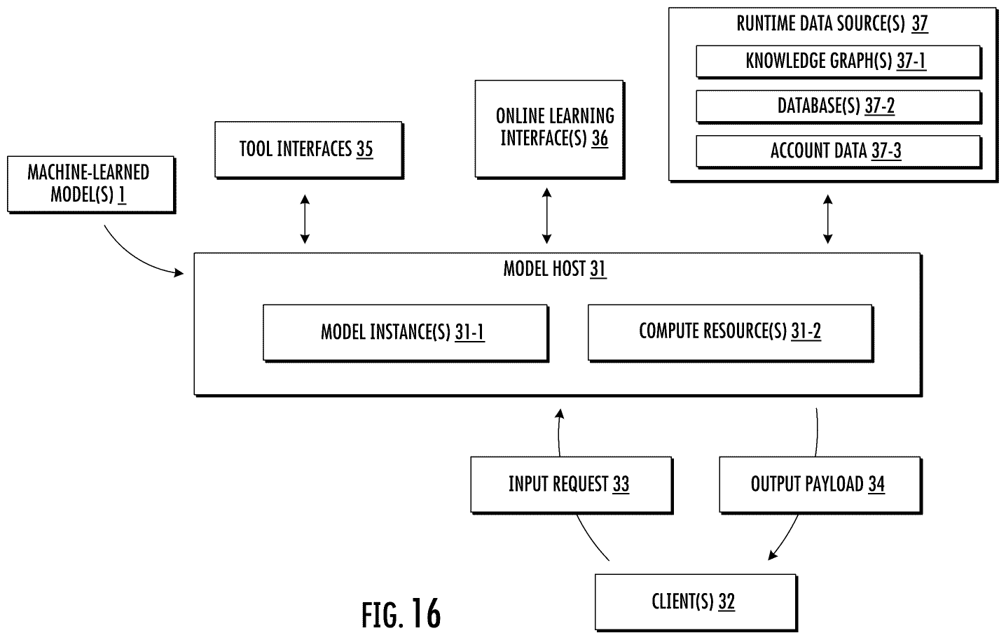

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2.

Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance.

Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s).

Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

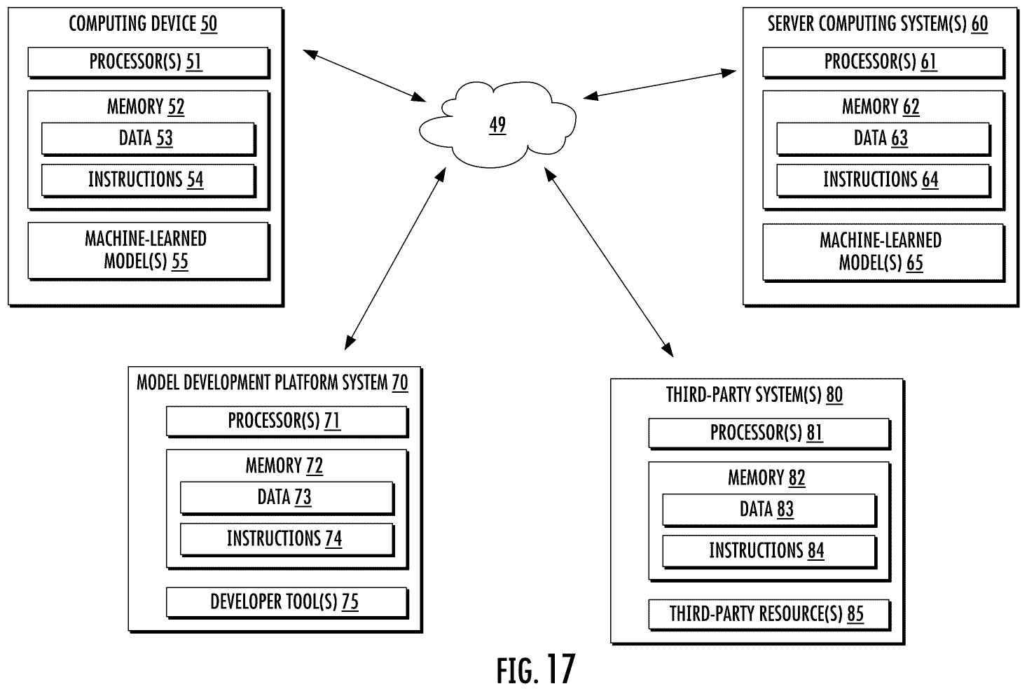

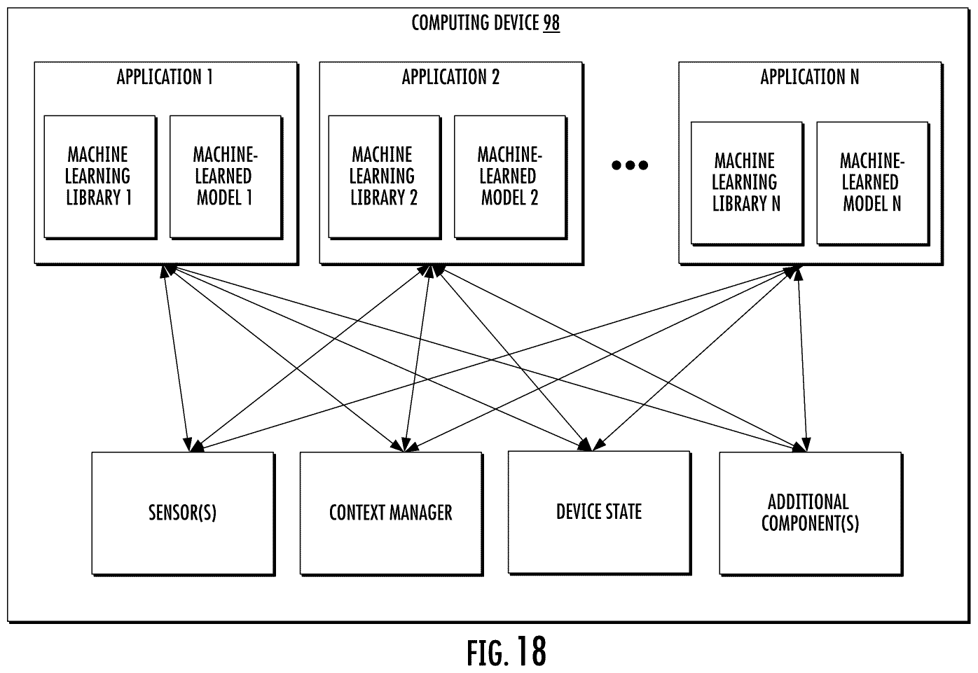

FIG. 17 is a block diagram of an example networked computing system that can perform aspects of example implementations of the disclosure. The system can include a number of computing devices and systems that are communicatively coupled over a network 49. An example computing device 50 is described to provide an example of a computing device that can perform any aspect of the disclosure (e.g., implementing model host 31, client(s) 32, or both). An example server computing system 60 is described as an example of a server computing system that can perform any aspect of the disclosure (e.g., implementing model host 31, client(s) 32, or both). Computing device 50 and server computing system(s) 60 can cooperatively interact (e.g., over network 49) to perform any aspect of the disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

FIG. 18 is a block diagram of an example computing device 98 that performs according to example embodiments of the disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, a social media application, a chat application, an item recommendation application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

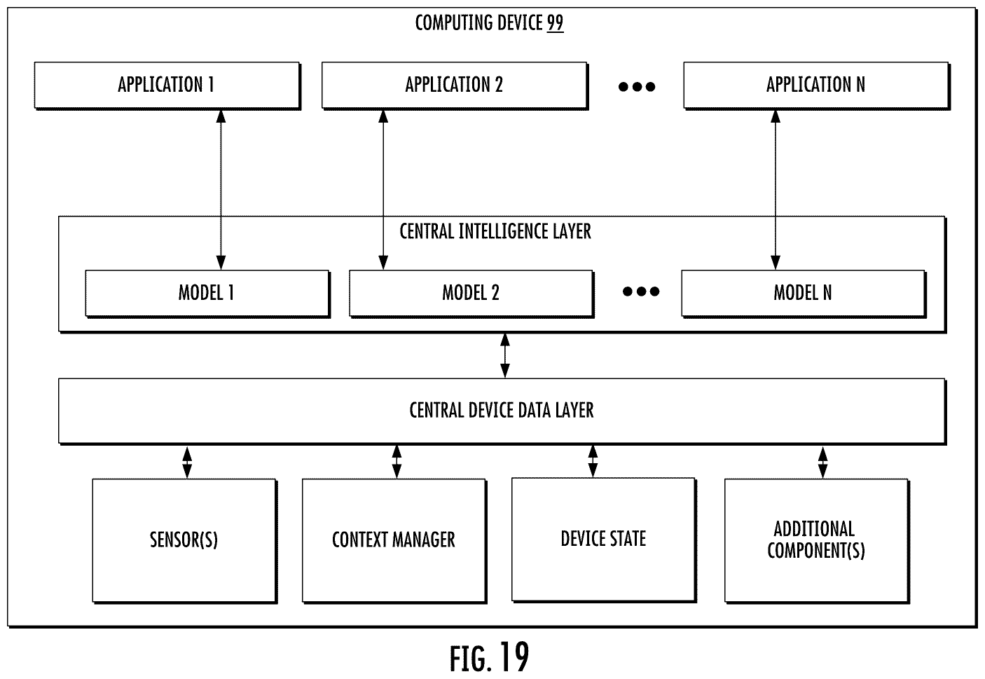

FIG. 19 is a block diagram of an example computing device 99 that performs according to example embodiments of the disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, a social media application, a chat application, an item recommendation application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computing device, comprising:
one or more memories configured to store instructions; and
one or more processors configured to execute the instructions to perform operations, the operations comprising:
implementing one or more machine-learned models configured to:
determine one or more acquisition features associated with a user relating to a first item prior to the user interacting with the first item, and
determine one or more experiential features relating to interactions with the first item or one or more other items; and
generating a dataset based on the one or more acquisition features and the one or more experiential features.

2. The computing device of claim 1, wherein
the operations further comprise obtaining information from one or more reviews associated with the first item and/or at least one other item, and
the one or more machine-learned models are configured to determine the one or more acquisition features associated with the user based on the information from the one or more reviews associated with the first item and/or the at least one other item.

3. The computing device of claim 1, wherein the operations further comprise generating a rationale for determining the one or more acquisition features.

4. The computing device of claim 1, wherein the one or more acquisition features include a first acquisition feature which is determined based on information associated with the user which explicitly indicates one or more reasons for the user acquiring the first item prior to interacting with the first item.

5. The computing device of claim 4, wherein the one or more acquisition features include a second acquisition feature which is determined based on information associated with the user which implicitly indicates one or more reasons for the user acquiring the first item prior to interacting with the first item.

6. The computing device of claim 4, wherein the one or more experiential features include a first experiential feature which is determined based on information associated with the user or one or more other users which indicates whether the first item satisfied expectations of the user or the one or more other users after interacting with the first item.

7. The computing device of claim 1, wherein the operations further comprise:
determining, based on the one or more acquisition features associated with the user included in the dataset, information indicating one or more reasons for the user desiring to obtain the first item; and
providing, for presentation to the user, a recommendation related to a second item, based on the information indicating the one or more reasons for the user desiring to obtain the first item and one or more experiential features included in the dataset relating to the second item.

8. The computing device of claim 1, wherein the operations further comprise:
receiving a query related to a second item from the user;
in response to receiving the query, determining, based on the one or more acquisition features associated with the user included in the dataset, information indicating one or more reasons for the user desiring to obtain the first item; and
providing, for presentation to the user, a recommendation related to the second item, based on the information indicating the one or more reasons for the user desiring to obtain the first item and one or more experiential features included in the dataset relating to the second item.

9. The computing device of claim 1, wherein the one or more acquisition features are specified separately from the one or more experiential features in the dataset.

10. The computing device of claim 1, wherein
the operations further comprise obtaining information from a plurality of reviews associated with the user relating to a plurality of items other than the first item, and
the one or more machine-learned models are configured to determine the one or more acquisition features associated with the user based on the information from the plurality of reviews associated with the user relating to the plurality of items other than the first item.

11. The computing device of claim 10, wherein the one or more machine-learned models are configured to limit a number of reviews associated with the user for determining the one or more acquisition features to a predetermined number of reviews most recently provided by the user.

12. A computer-implemented method, comprising:
implementing, by a computing system comprising one or more processors, one or more machine-learned models to determine one or more acquisition features associated with a user relating to a first item prior to the user interacting with the first item;
implementing, by the computing system, the one or more machine-learned models to determine one or more experiential features relating to interactions with the first item or one or more other items; and
generating a dataset based on the one or more acquisition features and the one or more experiential features.

13. The computer-implemented method of claim 12, further comprising obtaining information from one or more reviews associated with the first item and/or at least one other item, and
wherein the one or more machine-learned models determine the one or more acquisition features associated with the user based on the information from the one or more reviews associated with the first item and/or the at least one other item.

14. The computer-implemented method of claim 12, further comprising:
generating a rationale for determining the one or more acquisition features.

15. The computer-implemented method of claim 12, wherein the one or more acquisition features include a first acquisition feature which is determined based on information associated with the user which explicitly indicates one or more reasons for the user acquiring the first item prior to interacting with the first item.

16. The computer-implemented method of claim 15, wherein the one or more acquisition features include a second acquisition feature which is determined based on information associated with the user which implicitly indicates one or more reasons for the user acquiring the first item prior to interacting with the first item.

17. The computer-implemented method of claim 15, wherein the one or more experiential features include a first experiential feature which is determined based on information associated with the user or one or more other users which indicates whether the first item satisfied expectations of the user or the one or more other users after interacting with the first item.

18. The computer-implemented method of claim 12, further comprising:
determining, based on the one or more acquisition features associated with the user included in the dataset, information indicating one or more reasons for the user desiring to obtain the first item; and
providing, for presentation to the user, a recommendation related to a second item, based on the information indicating the one or more reasons for the user desiring to obtain the first item and one or more experiential features included in the dataset relating to the second item.

19. The computer-implemented method of claim 12, further comprising:
receiving a query related to a second item from the user;
in response to receiving the query, determining, based on the one or more acquisition features associated with the user included in the dataset, information indicating one or more reasons for the user desiring to obtain the first item; and
providing, for presentation to the user, a recommendation related to the second item, based on the information indicating the one or more reasons for the user desiring to obtain the first item and one or more experiential features included in the dataset relating to the second item.

20. A non-transitory computer readable medium storing instructions which, when executed by a processor, cause the processor to perform operations, the operations comprising:
implementing one or more machine-learned models to determine one or more acquisition features associated with a user relating to a first item prior to the user interacting with the first item;
implementing the one or more machine-learned models to determine one or more experiential features relating to interactions with the first item or one or more other items; and
generating a dataset based on the one or more acquisition features and the one or more experiential features.

21. A computing device, comprising:
one or more memories configured to store instructions; and
one or more processors configured to execute the instructions to perform operations, the operations comprising:
receiving a query from a user relating to a first item; and
in response to receiving the query, implementing one or more machine-learned models configured to:
determine one or more acquisition features associated with the user relating to the first item prior to the user interacting with the first item,
determine one or more experiential features relating to interactions with the first item or one or more other items, and
provide, as an output, a recommendation of the first item based on the one or more acquisition features and the one or more experiential features.

22. The computing device of claim 21, wherein the one or more acquisition features associated with the user relating to the first item prior to the user interacting with the first item are retrieved by the one or more machine-learned models from a dataset which stores the one or more acquisition features associated with the user.

23. The computing device of claim 21, wherein the one or more machine-learned models are implemented in real-time.

24. A computing device, comprising:
one or more memories configured to store instructions; and
one or more processors configured to execute the instructions to perform operations, the operations comprising:
determining an occurrence of a predetermined condition with respect to a user; and
in response to determining the occurrence of the predetermined condition, implementing one or more machine-learned models configured to:
determine one or more acquisition features associated with the user relating to a first item prior to the user interacting with the first item,
determine one or more experiential features relating to interactions with the first item or one or more other items, and
provide, as an output, a recommendation of the first item based on the one or more acquisition features and the one or more experiential features.

25. The computing device of claim 24, wherein the one or more acquisition features associated with the user relating to the first item prior to the user interacting with the first item are retrieved by the one or more machine-learned models from a dataset which stores the one or more acquisition features associated with the user.

26. The computing device of claim 24, wherein the one or more machine-learned models are implemented in real-time.

27. The computing device of claim 24, wherein the predetermined condition includes at least one of the user requesting to access content via a particular website, receiving an instruction provide a notification to the user, or determining a user has entered a particular geographic location.
